(19) United States
(12) Patent Application Publication
(10) Pub. No.: US 2015/0074666 A1
(43) Pub. Date: Mar. 12, 2015

(54) SUPPORT SYSTEM FOR CREATING OPERATION TASK PROCESS OF COMPUTER SYSTEM AND FIRST MANAGEMENT COMPUTER FOR SUPPORTING CREATION OF OPERATION TASK PROCESS

(71) Applicants: Masashi Kunii, Tokyo (JP); Daisuke Iizuka, Tokyo (JP)

(72) Inventors: Masashi Kunii, Tokyo (JP); Daisuke Iizuka, Tokyo (JP)

(73) Assignee: HITACHI, LTD., Tokyo (JP)

(21) Appl. No.: 14/391,188

(22) PCT Filed: Apr. 18, 2012
(86) PCT No.: PCT/JP2012/060454

§ 371 Date: Oct. 8, 2014

(51) Int. Cl. G06F 13/00; G06F 9/445

(52) U.S. Cl. CPC G06F 13/00; G06F 9/445
USPC 718/100

(57) ABSTRACT

A second management computer (a management server) acquires either all or a portion of a plurality of task components from a first management computer (a content management server), creates an operation task process based on the acquired plurality of task components, and executes an operation task of the computer system in accordance with the created operation task process. The second management computer manages the execution result of the operation task process, and supplies the execution result to the first management computer. The first management computer acquires, from the second management computer, the configuration information and the execution result of the operation task process, retrieves a task component candidate on the basis of a request from the second management computer, presents the task component candidate to the second management computer, and provides a selected task component to the second management computer.

### TECHNICAL FIELD

The present invention relates to a support system for creating an operation task process of a computer system and a first management computer for supporting the creation of the operation task process.

### BACKGROUND ART

A computer system comprising various information technology (IT) equipment, such as a server, a network apparatus, and a storage apparatus, performs such operation tasks as an installation process for a variety of software and a data backup process.

When a worker performs these operation tasks manually, there is the possibility of an operational error occurring caused by the worker's lack of experience or carelessness. When an operational error occurs, additional work becomes necessary, thus prolonging working hours.

In order to reduce human operational errors, it has been proposed that manual operation-based operation tasks be converted beforehand to a script or other such automated operation flow. Automated processing, which makes it possible to perform operation tasks in a short time with little need for human intervention by providing parameters for this automated operation flow and executing the processing, is becoming widespread. Thus, RunBook Automation (RBA) products that automate operation tasks that were heretofore done manually are gaining attention. The automated operation flow is created by combining components that automate individual procedures. The components may be pre-installed in the RBA product.

Although not a technique related to a system for supporting the creation of an operation task process for a computer system, a technique that uses an execution history to predict the completion time for processing currently being executed is known (PTL 1).

### CITATION LIST

### Patent Literature

### [PTL 1]

### Japanese Patent Application Publication No. 2007-102706

### SUMMARY OF INVENTION

### Technical Problem

There is an infinite variety of configurations for a management-target system, and the automated operation flow suitable for an operation task is determined in accordance with a specific system configuration. Therefore, it is difficult for a user to obtain an off-the-shelf product with the desired automated operation flow.

Thus, it takes time and effort, and is inconvenient for the user to create a new automated operation flow tailored to the management-target system.

With the foregoing problem in view, an object of the present invention is to provide a support system that makes it possible to support the creation of an operation task process for a computer system, and a first management computer for supporting the creation of the operation task process.

### Solution to Problem

To solve for the aforementioned problem, a system that conforms to the present invention comprises: a first management computer, which is communicably connected to at least one or more second management computers, and which manages information related to an operation task process performed by the second management computer and manages information related to a plurality of task components; and a second management computer, which manages a computer system that includes at least one or more management-target apparatuses, and which executes an operation task of the computer system in accordance with the operation task process created comprising a plurality of predetermined task components, wherein the second management computer comprises: a configuration information management part for managing information related to the configuration of the computer system; a task component acquisition part for acquiring from the first management computer either all or a portion of the plurality of predetermined task components; an operation task execution part for creating an operation task process based on the plurality of predetermined task components acquired by the task component acquisition part, and for executing an operation task of the computer system in accordance with the created operation task process; and an execution result management part for managing an execution result of an operation task process by the operation task execution part, and supplying the execution result to the first management computer, and the first management computer comprises: an information acquisition part for acquiring, from the second management computer, configuration information related to the configuration of the computer system managed by the configuration information management part and an operation task process execution result managed by the execution result management part; a storage part for storing the configuration information and operation task process execution results acquired by the information acquisition part; a task component retrieval part for retrieving, on the basis of a request from the task component acquisition part, a task component candidate, which is a candidate from the plurality of predetermined task components, and for presenting the retrieved task component candidate to the task component acquisition part; and a task component provision part for providing, to the task component acquisition part, a task component selected by the task component acquisition part from among task component candidates.

### BRIEF DESCRIPTION OF DRAWINGS

FIG. 1 illustrates the overall configuration of a system in this example.

FIG. 2 illustrates the configuration of an operation management system.

FIG. 3 illustrates the configuration of a management server.

FIG. 4 illustrates the configuration of a content provision system.

FIG. 5 illustrates a data flow.

FIG. 6 illustrates a constructional example of a flow list.

FIG. 7 illustrates a constructional example of a task list.

FIG. 8 illustrates a constructional example of a task log file list.

FIG. 9 illustrates a constructional example of a task history list.

FIG. 10 illustrates a constructional example of a contents list.

FIG. 11 illustrates a constructional example of a task tag list.

FIG. 12 illustrates a constructional example of an execution performance list.

FIG. 13 illustrates a constructional example of a task performance list.

FIG. 14 illustrates a constructional example of a partial flow performance list.

FIG. 15 illustrates a constructional example of a search keyword input screen.

FIG. 16 illustrates a constructional example of a search result screen.

FIG. 17 is a flowchart illustrating a series of processes by a management server and a content management server.

FIG. 18 is a flowchart illustrating Step S1 of FIG. 17 in detail.

FIG. 19 is a flowchart illustrating Step S2 of FIG. 17 in detail.

FIG. 20 is a flowchart illustrating Step S3 of FIG. 17 in detail.

FIG. 21 is a flowchart illustrating Step S4 of FIG. 17 and FIG. 33 in detail.

FIG. 22 is a flowchart illustrating Step S5 of FIG. 17 and FIG. 33 in detail.

FIG. 23 is a flowchart illustrating Step S6 of FIG. 17 and FIG. 33 in detail.

FIG. 24 illustrates a constructional example of a task log file list related to a second example of the present invention.

FIG. 25 illustrates a constructional example of a task history list.

FIG. 26 illustrates a constructional example of an apparatus ID list.

FIG. 27 illustrates a constructional example of a configuration information list.

FIG. 28 illustrates a constructional example of an execution performance list.

FIG. 29 illustrates a constructional example of a task performance list.

FIG. 30 illustrates a constructional example of a partial flow performance list.

FIG. 31 illustrates a constructional example of a search keyword input screen.

FIG. 32 illustrates a constructional example of a search result list.

FIG. 33 is a flowchart illustrating a series of processes by the management server and the content management server.

FIG. 34 is a flowchart illustrating Step S1A of FIG. 33 in detail.

FIG. 35 is a flowchart illustrating Step S16A of FIG. 34 in detail.

FIG. 36 is a flowchart illustrating Step S2A of FIG. 33 in detail.

FIG. 37 is a flowchart illustrating Step S3A of FIG. 33 in detail.

### DESCRIPTION OF EMBODIMENTS

An embodiment of the present invention will be explained below on the basis of the drawings. The configuration described in the specification and depicted in the drawings appended to the specification is merely one example, and does not limit either the scope of the claims of the invention or any interpretation of an example of an application thereof.

In the embodiment, the invention is explained insufficient detail for a so-called person skilled in the art to put the invention into practice, and the present invention can also use a configuration other than the configuration described in the embodiment. A so-called person skilled in the art should be able to add a new configuration, remove a portion of the configuration illustrated in the drawings, or replace the configuration illustrated in the drawings with another configuration without departing from the scope and spirit of the technical ideas of the present invention.

The embodiment, as will be described below, may be implemented as software run on a general-purpose computer, may be implemented as dedicated hardware, or may be implemented via a combination of software and hardware.

In the following explanation, various information of the present invention is explained using a “table” format, but the information does not necessarily have to be expressed using a data structure that accords with a table, and may be expressed using a list, a database (DB), a queue or other such data structure, or other configuration. In order to show that the information is not dependent on a data structure, a “table”, a “list”, a “DB”, a “queue” and the like may simply be called “information”.

When explaining the contents of the various information, it is possible to use an expression like “identification information”, “identifier”, “name”, or “ID”, but these expressions are interchangeable.

To explain the operation of the embodiment, there may be cases where “program” is used as the subject of the sentence (doer of the action). A computer program performs a stipulated process in accordance with being executed by a microprocessor while using a memory and a communication port (communication control apparatus) as needed. Therefore, a process may be explained having the processor as the subject of the sentence. A process that has been disclosed having the program as the subject of the sentence may be a process that is performed by a management server or other such computer, or an information processing apparatus. Either all or a portion of the programs may be realized using dedicated hardware. Either all or a portion of the programs may be modularized. Various programs may be installed in respective computers using either a program delivery server or storage media.

According to the embodiment, as will be described below, when executing an operation task process, the execution result (for example, execution history information) of each task component comprising the operation task process is recorded and collected. When creating a new operation task process, a user obtains a task component to be used in the new operation task process from the first management computer. At this time, the first management computer presents a task component candidate execution result (or the execution result and an evaluation result) to the user via the second management computer. Therefore, the user is able to construct a reliable operation task process relatively easily.

### Example 1

A mode for putting the invention into practice will be described below in accordance with the drawings. In the drawings, a portion of the names are described in an abbreviated manner for the sake of convenience.

In this example, as will be described hereinbelow, when an automated operation flow is executed as an example of an “operation task process”, task history information, such as an execution start time, an end time, and the presence or absence of an error for each task component comprising this automated operation flow, is stored in a management server that serves as an example of a “second management computer”.

A content management server that serves as an example of a “first management computer” collects the task history information from each management server, and stores this task history information as execution results information for the task component. When the user requests that the content management server retrieve a task component, the content management server retrieves a task component that matches the user's request. When a group of task components for which there is a record of having been executed consecutively exists among a combination of retrieved task components, the content management server presents the execution results, such as the stability of the task component group when executed consecutively, and the combination of task components to the user as a partial flow that serves as an example of a “predetermined combination”.

There may be cases where it is possible for at least of portion of the configuration described hereinbelow to be removed and/or replaced with another configuration. Not all of the items of the configuration of information in table format illustrated in the drawings need to be provided, and there may be cases where it is possible for a portion of the items to be removed and/or replaced with other items. In addition, there may also be cases where another item besides the items illustrated in the drawings can be added.

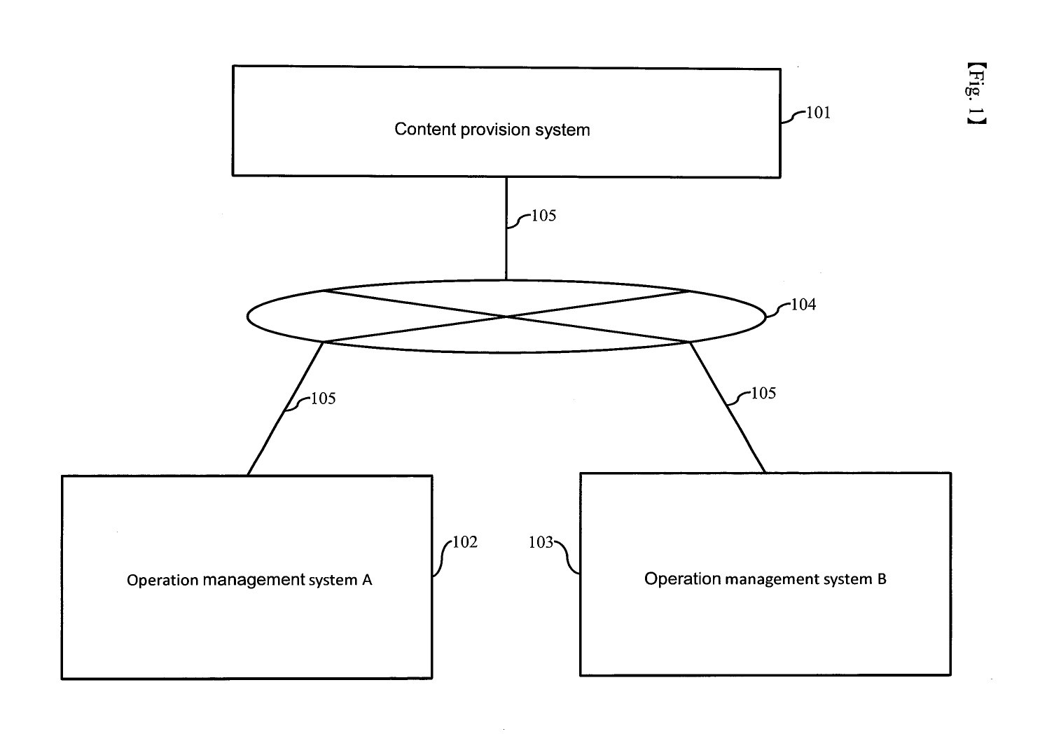

FIG. 1 illustrates an example of the overall configuration of a creation support system for an operation task process of a computer system related to the first example. The system comprises at least one content provision system 101, and at least one (for example, two or more) operation management systems 102, 103, and the content provision system 101 and the operation management systems 102 and 103 are connected via a communication network 104.

The content provision system 101 provides content to the operation management system 102 and the operation management system 103. The content provision system 101 is connected to the communication network 104 via a link 105. The operation management system 102 and the operation management system 103 are also connected to the communication network 104 via a link 105.

There may be one or more content provision systems 101. There may be just one of either the operation management system 102 or the operation management system 103, or there may be two or more.

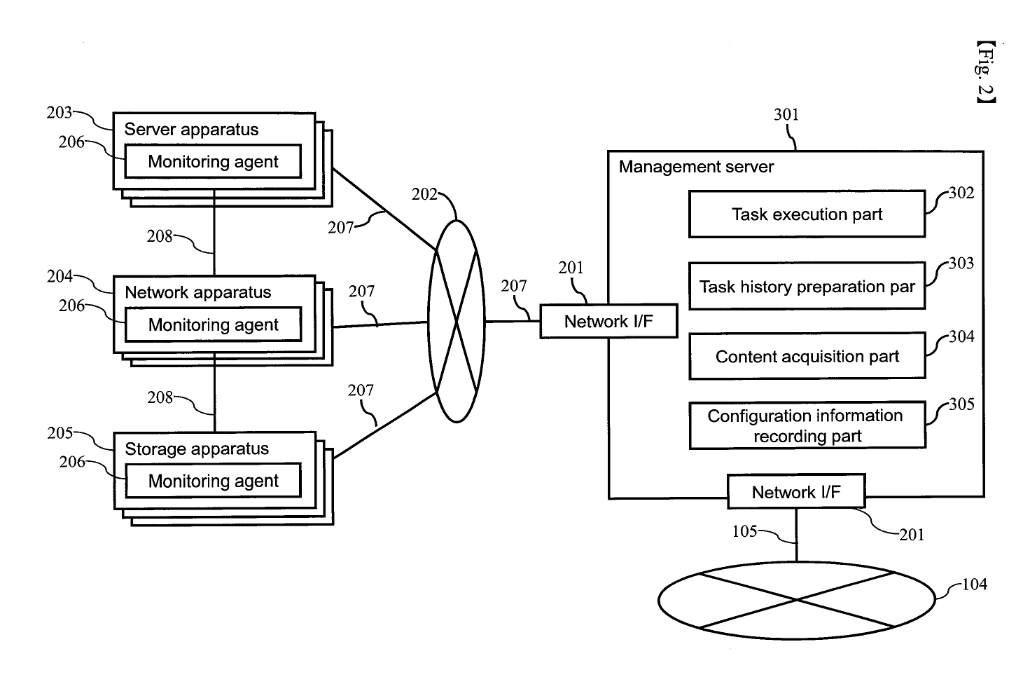

FIG. 2 is an example of a drawing showing the system configuration of the operation management system 102 and the operation management system 103.

An information processing system, which is an example of a “computer system”, for example, comprises a management server 301, a server apparatus 203, a network apparatus 204, and a storage apparatus 205. The server apparatus 203, the network apparatus 204, and the storage apparatus 205 are examples of a “management-target apparatus”. The server apparatus 203, the network apparatus 204, and the storage apparatus 205 can each comprise a monitoring agent 206. The monitoring agent 206 monitors a monitoring-target state, and notifies the management server 301 of the monitoring result.

The management server 301 is connected to the communication network 104 via a network interface 201 and a link 105. The management server 301 is connected to a management network 202 via a link 207. Similarly, the server apparatus 203, the network apparatus 204, and the storage apparatus 205 are also connected to the management network 202 via links 207.

The server apparatus 203 and the storage apparatus 205 are connected to the network apparatus 204 via links 208. The server apparatus 203 accesses the storage apparatus 205 via the network apparatus 204, and reads/writes data from/to a logical volume (not shown in the drawing) inside the storage apparatus 205.

The links 207 and 208 are either wired or wireless connection modes, and may include one or more sub-networks or virtual private networks (VPNs). The management server 301, the server apparatus 203, the network apparatus 204, and the storage apparatus 205 may each be different systems, and may be connected to the management network 202 or the network apparatus 204. The server apparatus 203 and the storage apparatus 205 may be connected directly using either a wired or wireless connection mode without going through the network apparatus 204.

The server apparatus 203, the network apparatus 204, and the storage apparatus 205 are illustrated as each having a plurality of units, but may have one unit each, respectively. The management server 301 is illustrated as having only one unit, but there may be a plurality of management servers.

The management server 301, the server apparatus 203, the network apparatus 204, and the storage apparatus 205 may be configured as a virtual management server, a virtual server apparatus, a virtual network apparatus, and a virtual storage apparatus.

Also, any two or more of the management server 301, the server apparatus 203, the network apparatus 204, and the storage apparatus 205 may be disposed inside the same enclosure, and may be configured as the same virtual apparatus.

The network apparatus 204 may be connected to another network apparatus 204 via either a wired or a wireless connection mode. The network provided by the network apparatus 204 may be the same as the management network 202. The link 207 and the link 208 may also be the same.

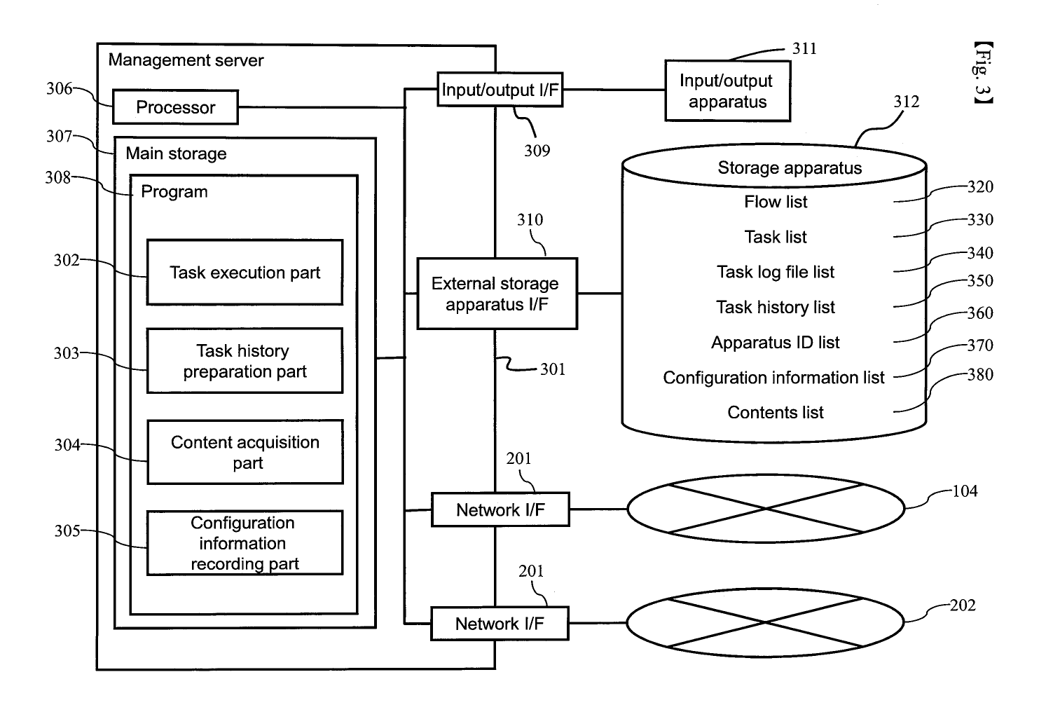

An example of the configuration of the management server 301 will be explained. The management server 301, for example, comprises a task execution part 302, a task history preparation part 303, a content acquisition part 304, and a configuration information recording part 305. The management server 301 will be explained in detail using FIG. 3.

FIG. 3 is an example of the configuration of the management server 301. The management server 301, for example, comprises a processor 306, a main storage 307, an input/output interface 309, an external storage apparatus interface 310, a network interface 201, an input/output apparatus 311, and a storage apparatus 312, and these elements are connected so as to be able to communicate with one another.

The respective processing of the task execution part 302, the task history preparation part 303, the content acquisition part 304, and the configuration information recording part 305 is executed in accordance with the processor 306 executing various programs 308 of the task execution part 302, the task history preparation part 303, the content acquisition part 304, and the configuration information recording part 305, that are stored in the main storage 307.

The task execution part 302 is an example of the “operation task execution part”. The task history preparation part 303 is an example of the “execution result management part”. The content acquisition part 304 is an example of the “task component acquisition part”. The configuration information recording part 305 is an example of the “configuration information management part”. To simplify the explanation, the respective processing parts realized in accordance with the processor 306 executing the various programs 308 on the main storage 307 will be explained as the respective processing entities.

The external storage apparatus interface 310 is connected to the storage apparatus 312. The storage apparatus 312, for example, is configured as a storage apparatus such as a hard disk drive or flash memory device. The storage apparatus 312 may be disposed outside of the management server 301, or may be disposed inside of the management server 301.

The storage apparatus 312, for example, holds various management information, such as a flow list 320, a task list 330, a task log file list 340, a task history list 350, an apparatus ID list 360, a configuration information list 370, and a contents list 380.

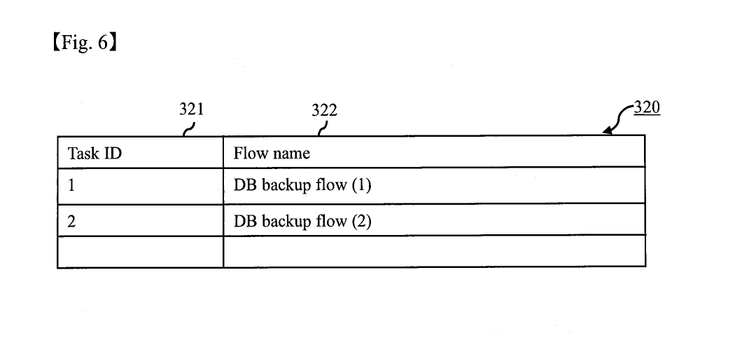

One piece of management information of the various management information may be joined with another piece of management information, and/or one piece of management information may be divided into multiple pieces of management information. At least a portion of the various management information held by the storage apparatus 312 may be stored in the main storage 307. Each management type information will be explained in detail using FIGS. 6 through 10, and FIGS. 24 through 27.

The network interface 201 is connected to the communication network 104 and the management network 202. The network interface 201 and the external storage apparatus interface 310 may be configured as the same interface.

The management server 301 is connected to the input/output apparatus 311 via the input/output interface 309. The input/output apparatus 311 comprises an information output apparatus for providing information to the user, and an information input apparatus for receiving information (including instructions, selections, and so forth) input from the user.

The information output apparatus, for example, may be a display apparatus, a printer apparatus, a synthesized speech output apparatus or the like. The information input apparatus, for example, may be a keyboard, a mouse or other such pointing apparatus, a push-button switch, a voice instruction apparatus or the like. A tablet apparatus that enables the input of information and the output of information to be performed simultaneously may be used.

The input/output apparatus 311 may be configured as a computer terminal that is connected either by wire or wirelessly to the management server 301, and may be configured like a personal digital assistant or mobile telephone possessed by the system administrator (user).

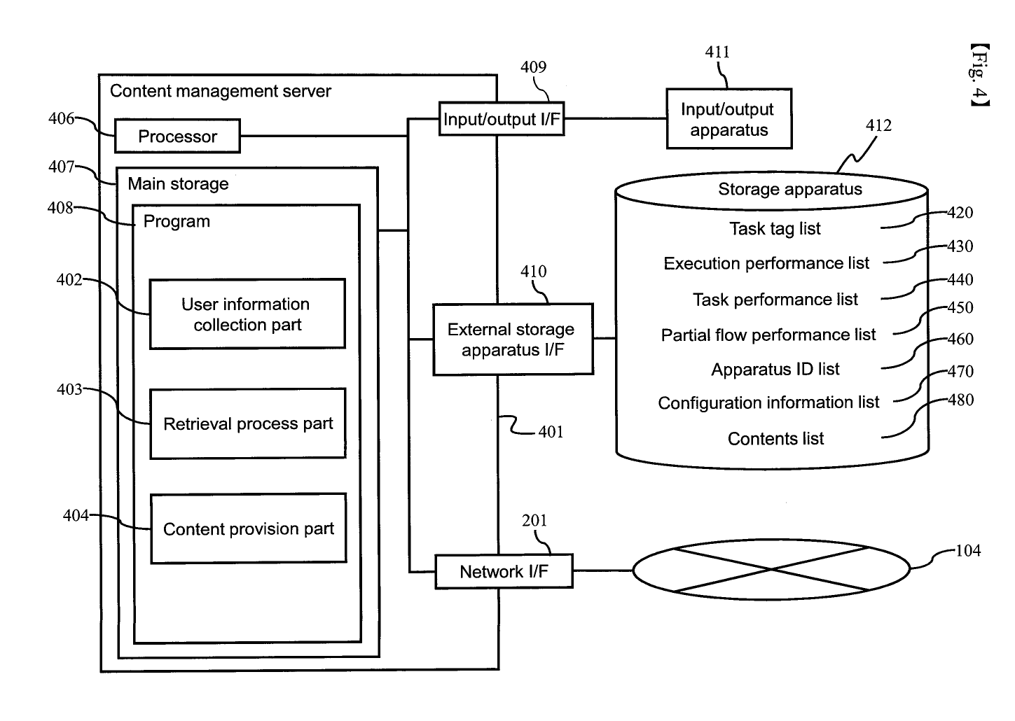

FIG. 4 illustrates an example of the configuration of the content management server 401 that comprises the core of the content provision system 101.

The content management server 401, for example, comprises a processor 406, a main storage 407, an input/output interface 409, an external storage apparatus interface 410, a network interface 201, an input/output apparatus 411, and a storage apparatus 412, and these elements are connected so as to be able to communicate with one another.

A user information collection part 402, a retrieval process part 403, and a content provision part 404 are executed in accordance with the processor 406 executing the various programs 408 of the user information collection part 402, the retrieval process part 403, and the content provision part 404.

The external storage apparatus interface 410 is connected to a storage apparatus 412 such as a hard disk drive or a flash memory device. The storage apparatus 412 may be disposed either outside or inside the content management server 401.

The storage apparatus 412 holds various management information, such as a task tag list 420, an execution performance list 430, a task performance list 440, a partial flow performance list 450, an apparatus ID list 460, a configuration information list 470, and a contents list 480.

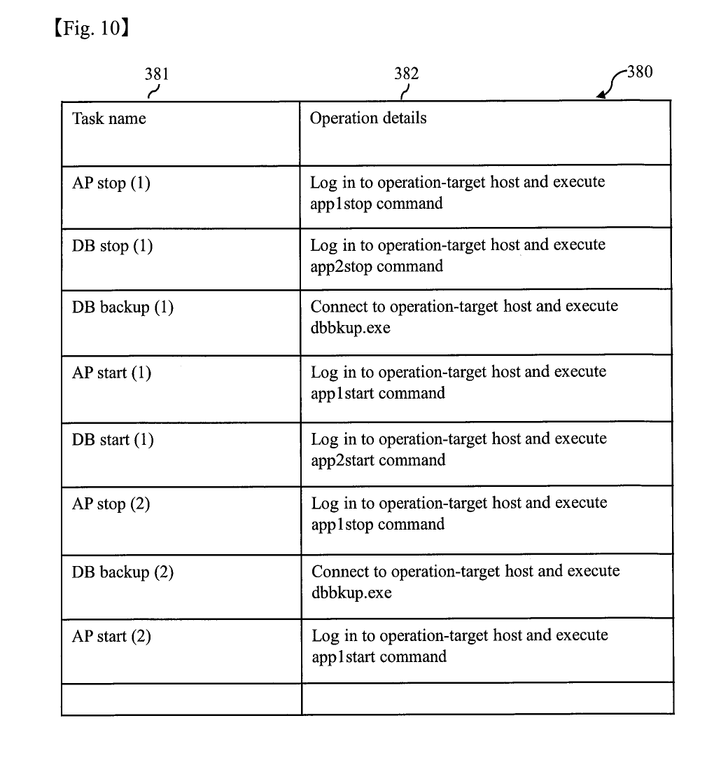

As was explained using FIG. 3, one piece of management information of the various management information may be joined with another piece of management information, and/or one piece of management information may be divided into multiple pieces of management information. One or more pieces of management information of the various management information held by the storage apparatus 412 may be stored in the main storage 407. The various management information will be explained later using FIGS. 10 through 14, and FIGS. 26 through 30.

The network interface 201 is connected to the communication network 104. The network interface 201 and the external storage apparatus interface 410 may be configured as the same interface.

The content management server 401 is connected to the input/output apparatus 411 via the input/output interface 409. The input/output apparatus 411 can be configured the same as the input/output apparatus 311 explained using FIG. 3.

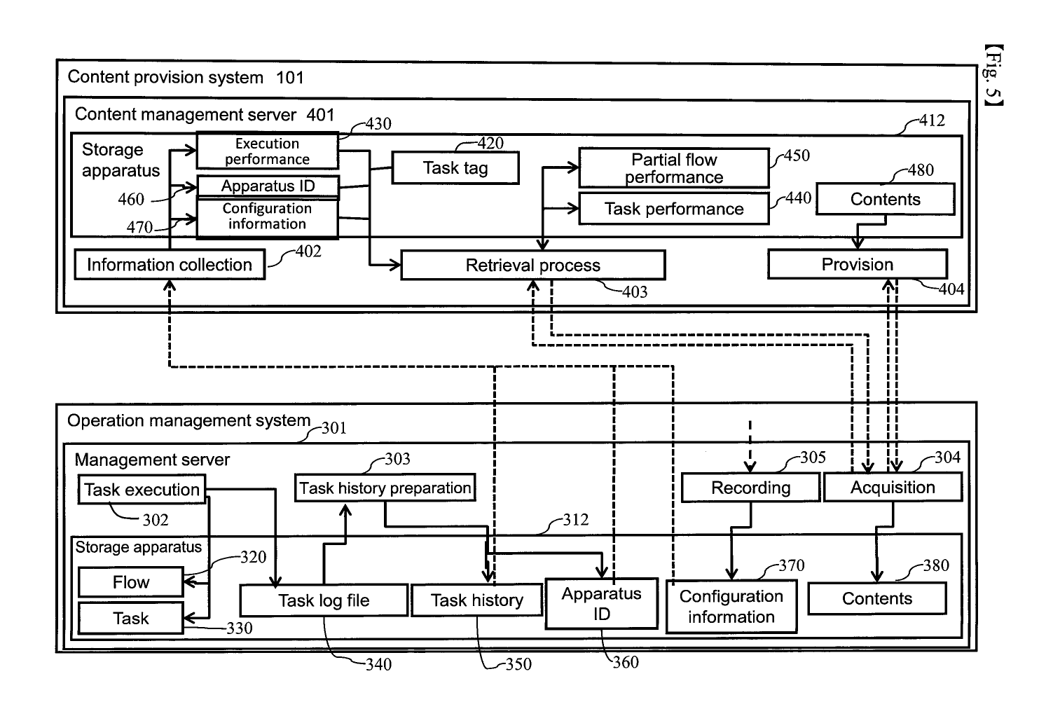

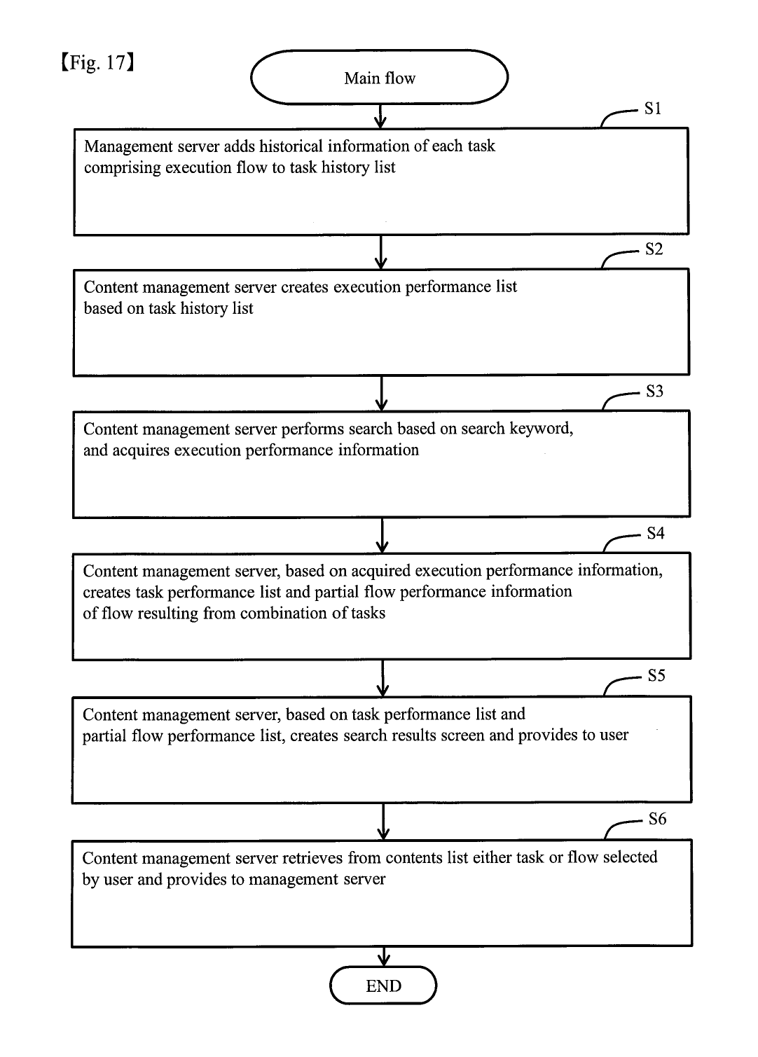

FIG. 5 is a schematic drawing showing the flow of data. The processing performed by the task execution part 302, the task history preparation part 303, the content acquisition part 304, and the configuration information recording part 305, which are the various programs 308 of the management server 301, and the processing performed by the user information collection part 402, the retrieval process part 403, and the content provision part 404, which are the various programs 408 of the content management server 401, will be described briefly in chronological order below. Details will be described in the explanations of FIGS. 17 through 23, and FIGS. 33 through 37.

The task execution part 302 references the flow list 320 and the task list 330, and executes an automated operation flow. The task execution part 302 records, in the task log file list 340, the execution result of each task component comprising the executed automated operation flow.

The task history preparation part 303 references the task log file list 340, and records the task history in the task history list 350 and the apparatus ID list 360.

The configuration information recording part 305 collects the configuration information of the management-target apparatuses (the server apparatus 203, the network apparatus 204, and the storage apparatus 205) and records this configuration information in the configuration information list 370.

The user information collection part 402 respectively collects the task history lists 350, the apparatus ID lists 360, and the configuration information lists 370 from the operation management systems 102 and 103, and records these lists 350, 360, and 370 in the execution performance list 430, the apparatus ID list 460, and the configuration information list 470.

The retrieval process part 403 references the task tag list 420 and the configuration information list 470, and creates a search keyword input screen D1. The search keyword input screen D1 will be described in detail below.

The content acquisition part 304 sends a search condition input via the search keyword input screen D1 by the user of the content provision system (hereinafter, user) to the retrieval process part 403.

The retrieval process part 403, upon receiving the search condition, references the execution performance list 430 and the apparatus ID list 470, and records the search condition in the task performance list 440 and the partial flow performance list 450. The retrieval process part 403 references the task performance list 440 and the partial flow performance list 450 on the basis of the search condition, and creates a search result screen D2. The search result screen D2 will be described in detail below.

The content acquisition part 304 sends user-requested content information input via the search result screen D2 by the user to the content provision part 404.

The content provision part 404 acquires the requested content from the contents list 480, and sends this content to the content acquisition part 304.

The content acquisition part 304, upon receiving the content from the content provision part 404, registers this content in the contents list 380.

FIG. 6 is an example of the flow list 320. The flow list 320 manages the automated operation flow. The “lists” described hereinbelow are each table formats, and are made up of one or more rows. The below “lists” may comprise other items besides the items (columns) illustrated in the drawings, and in some cases, a portion of the items may be omitted. The task component may be abbreviates as “task” hereinbelow.

The flow list 320, for example, includes a task ID 321 and a flow name 322. Identification information unique to each automated operation flow is registered in the task ID 321. The name of the automated operation flow is registered in the flow name 322. It is preferable that the name of the automated operation flow be described in a manner that the user can understand.

The task ID 321 and the flow name 322 are configured beforehand by the administrator of the operation management system (may coincide with the user of the content provision server). The task IDs 321 and the flow names 322 may all be configured manually, or may be configured using some sort of tool or utility program.

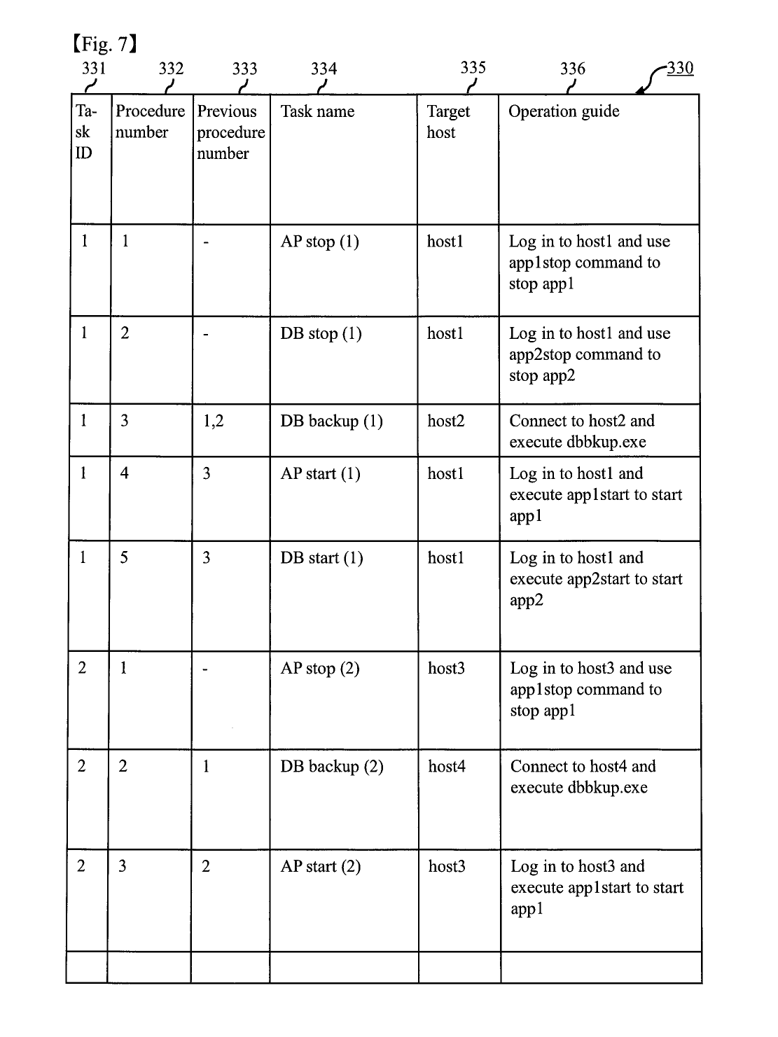

FIG. 7 is an example of the task list 330. The task list 330 manages the contents of one or more tasks comprising the automated operation flow. The task list 330, for example, includes a task ID 331, a procedure number 332, a previous procedure number 333, a task name 334, an operation-target hostname 335, and an operation guide 336.

A value that is the same as that of the identification information configured in the automated operation flow corresponding to each task is registered in the task ID 331.

Identification information for uniquely identifying a task procedure within the automated operation flow corresponding to each task is registered in the procedure number 332. The procedure number 332 indicates the execution order of the tasks within the automated operation flow.

The procedure number 332 of another task for which execution must be complete before the execution of a certain task in a plurality of tasks comprising one certain automated operation flow is registered in the previous procedure number 333. For example, in the example of FIG. 7, the tasks for procedure numbers “1” and “2” must be completed first before performing the task (database backup 2) for procedure number “3”.

A name indicating the task content is registered in the task name 334. The task name 334 is information for uniquely identifying the task content.

Identification information for an operation-target host is registered in the operation-target hostname 335. Host here is the generic term for the server apparatus 203, the network apparatus 204, and the storage apparatus 205, which are the management-target apparatuses.

The task content is registered in the operation guide 336 using a character string that the system administrator (user) is able to understand.

The task ID 331, the procedure number 332, the previous procedure number 333, the task name 334, the operation-target hostname 335, and the operation guide 336 are configured beforehand by the system administrator. The system administrator may configure the task ID 331, the procedure number 332, the previous procedure number 333, the task name 334, the operation-target hostname 335, and the operation guide 336 manually, or by using some sort of tool or utility program.

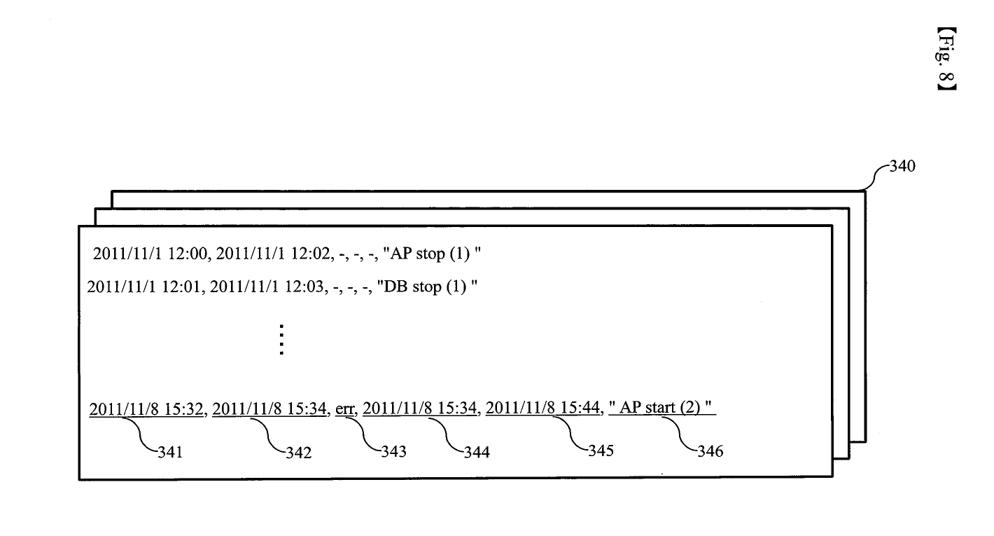

FIG. 8 is an example of the task log file list 340. The task log file list 340 manages a log file of executed tasks. One task log is described per row in the task log files included in the task log file list 340.

The task log, for example, can include a task start time 341, a task end time 342, an error status 343, a recovery process start time 344, a recovery process end time 345, and a task name 346.

The task start time 341 includes the date and time at which a task execution started. The task end time 342 includes the date and time at which the task execution ended.

The error status 343, which represents basic information regarding “error-related information”, indicates whether or not a task has ended normally. A “−” signifies a normal end, and “err” signifies an abnormal end.

The recovery process start time 344 includes the date and time at which a recovery process, which is executed when a task ends abnormally, starts. The recovery process end time 345 includes the date and time at which the recovery process, which is executed when a task ends abnormally, ended.

The recovery process start time and/or the recovery process end time are examples of “information indicating the existence of a recovery process”. When either a recovery process start time or end time is recorded, the user knows that a recovery process has been provided beforehand for the implemented task.

The task name 346 is a name uniquely identifying the executed task content. The data structure of the task log file list 340 is not limited to the format illustrated in FIG. 8.

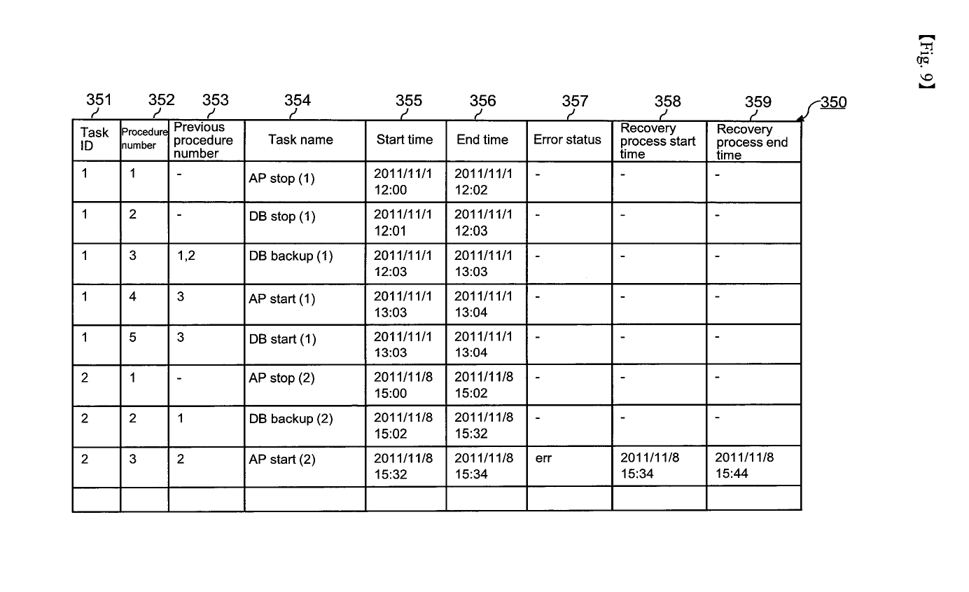

FIG. 9 is an example of the task history list 350.

The task history list 350 manages a history of executed tasks. The task history list 350, for example, includes a task ID 351, a procedure number 352, a previous procedure number 353, a task name 354, a start time 355, an end time 356, an error status 357, a recovery process start time 358, and a recovery process end time 359.

A value that is the same as that of the identification information for the automated operation flow corresponding to each task is registered in the task ID 351.

Identification information unique to a task procedure within the automated operation flow corresponding to each task is registered in the procedure number 352. The procedure number 352 of another task for which execution must be completed before the execution of a certain task in a plurality of tasks comprising a single flow is registered in the previous procedure number 353.

A name that uniquely identifies the task content is registered in the task name 354. A date and time at which the execution of the task started is registered in the start time 355. A date and time at which the execution of the task ended is registered in the end time 356.

Information as to whether or not a task ended normally is registered in the error status 357. A “−” signifies a normal end, and “err” signifies an abnormal end.

The date and time at which a recovery process, which is executed when a task ends abnormally, starts is registered in the recovery process start time 358. The date and time at which the recovery process, which is executed when a task ends abnormally, ended is registered in the recovery process end time 359.

The task ID 351, the procedure number 352, the previous procedure number 353, the task name 354, the start time 355, the end time 356, the error status 357, the recovery process start time 358, and the recovery process end time 359 are updated each time a task configuring the automated operation flow ends. The present invention is not limited thereto, and the configuration may be such that either a predetermined row or column of the task history list 350 is updated at another time other than when task ends.

The task history list 350 can be updated either manually, or by using some sort of tool or utility program.

FIG. 10 is an example of a contents list 380. The contents list 380 manages task components as content. The contents list 380, for example includes a task name 381, and operation details 382.

A name that uniquely identifies the task content is registered in the task name 381. The details of an operation when a relevant task has been executed are registered in the operation details 382.

The task name 381 and the operation details 382 are configured beforehand by the system administrator. The same as was described hereinabove, the system administrator may configure the task name 381 and the operation details 382 manually, or by using some sort of tool or utility program.

The contents list 480 managed by the content management server 401 has the same configuration as the contents list 380 managed by the management servers 301 in the respective operation management systems. Therefore, an explanation thereof will be omitted.

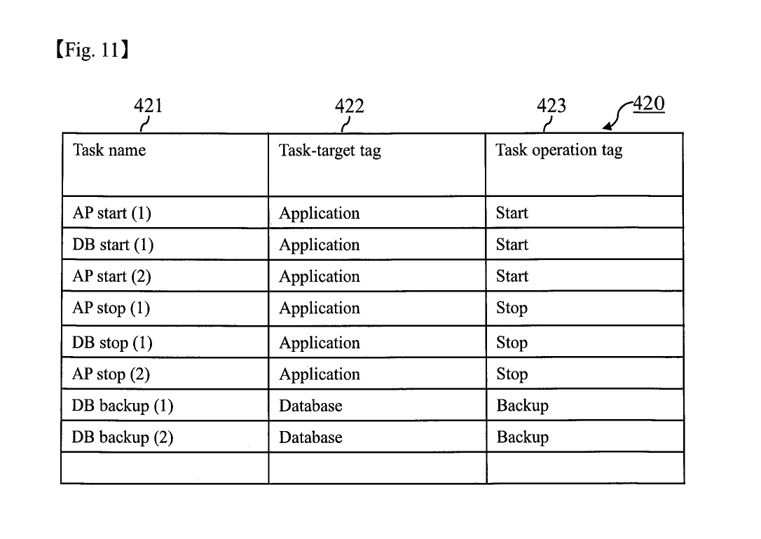

FIG. 11 is an example of the task tag list 420. The task tag list 420 manages a search tag for retrieving a task component. The task tag list 420, for example, includes a task name 421, a task-target tag 422, and a task operation tag 423.

A name that uniquely identifies the task content is registered in the task name 421. A keyword indicating a task-target type is registered in the task-target tag 422. A keyword indicating an operation that is performed in relation to a task target is registered in the task operation tag 423.

The task name 421, the task-target tag 422, and the task operation tag 423 are configured beforehand by the system administrator. The same as was described hereinabove, the task name 421, the task-target tag 422, and the task operation tag 423 may be configured manually, or may be configured using some sort of tool or utility program.

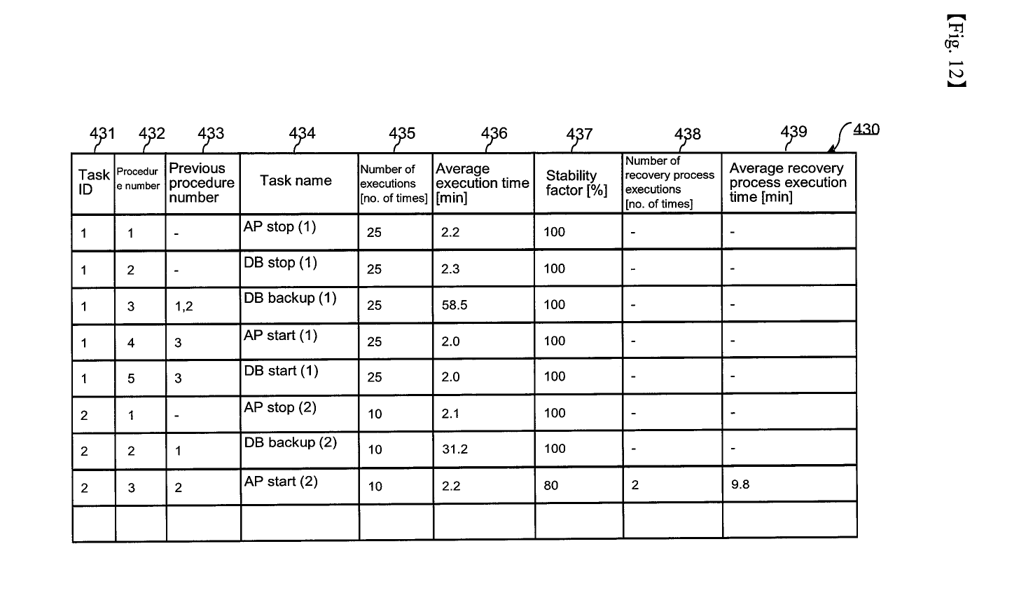

FIG. 12 is an example of the execution performance list 430. The execution performance list 430 manages the execution performance of task components. The execution performance list 430, for example, includes a task ID 431, a procedure number 432, a previous procedure number 433, a task name 434, a number of executions 435, an average execution time 436, a stability factor 437, a number of recovery process executions 438, and an average recovery process execution time 439.

The same identification information as that of the flow configured by each task is registered in the task ID 431. Identification information for uniquely identifying a task procedure within the automated operation flow corresponding to each task is registered in the procedure number 432. The procedure number 432 of another task for which execution must be complete before the execution of a certain task in a plurality of tasks comprising a single automated operation flow is registered in the previous procedure number 433.

A name for uniquely identifying the task content is registered in the task name 434. The number of times that the task was executed is registered in the number of executions 435. The average time required to complete the task is registered in the average execution time 436.

A probability of the task ending normally is registered in the stability factor 437. A number of times that a recovery process was executed when the task ended abnormally is registered in the number of recovery process executions 438. An average time required to complete a recovery process executed when the task ended abnormally is registered in the average recovery process execution time 439.

Any one or a plurality of the stability factor 437, the number of recovery process executions 438, and the average recovery process execution time 439 comprise an example of an “evaluation result”. A highly stable task component can be considered to have high reliability.

A task component with a large number of executions for the recovery process can be considered to have low reliability. However, a task component comprising a recovery process can also be evaluated highly in terms of reliability and usability compared to another task component that does not comprise a recovery process. A task component with a short average execution time for the recovery process can also be evaluated as having high reliability and usability compared to another task component for which the average execution time for the recovery process is long.

The task ID 431, the procedure number 432, the previous procedure number 433, the task name 434, the number of executions 435, the average execution time 436, the stability factor 437, the number of recovery process executions 438, and the average recovery process execution time 439 are updated each time the content management server 401 collects the task history list 350. However, updating may be performed at some other time.

The system administrator may update the execution performance list 430 at a predetermined time either manually, or using some sort of tool or utility program.

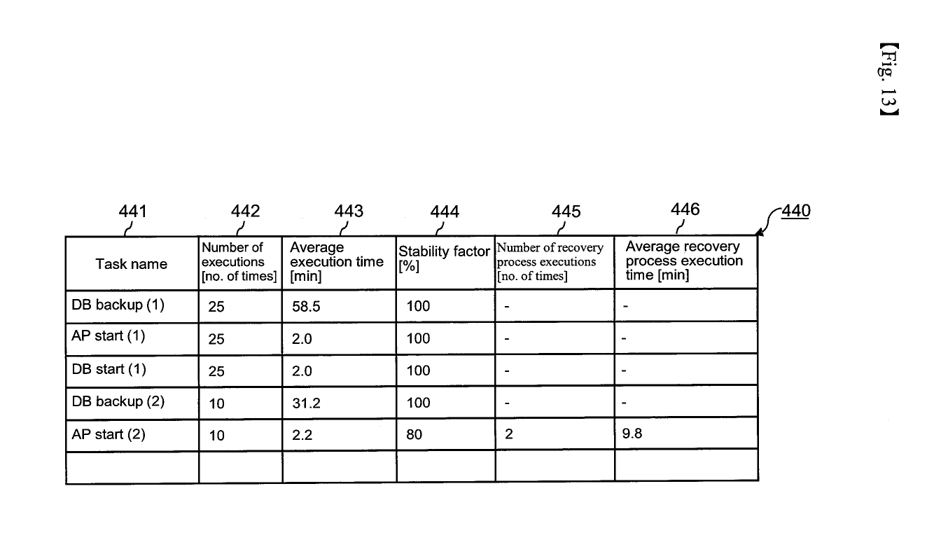

FIG. 13 is an example of the task performance list 440. The task performance list 440 tabulates and manages the performance of a task component. The task performance list 440, for example, includes a task name 441, a number of executions 442, an average execution time 443, a stability factor 444, a number of recovery process executions 445, and an average recovery process execution time 446.

A name for uniquely identifying the task content is registered in the task name 441. The number of times that the task was executed is registered in the number of executions 442. The average time required to complete the task is registered in the average execution time 443. A probability of the task ending normally is registered in the stability factor 444.

A number of times that a recovery process was executed when the task ended abnormally is registered in the number of recovery process executions 445. An average time required to complete a recovery process executed when the task ended abnormally is registered in the average recovery process execution time 446.

The task name 441, the number of executions 442, the average execution time 443, the stability factor 444, the number of recovery process executions 445, and the average recovery process execution time 446 are updated when a task component and a partial flow are retrieved. Updating may be performed at some other time. The system administrator may update the task performance list 440 at a predetermined time either manually, or using some sort of tool or utility.

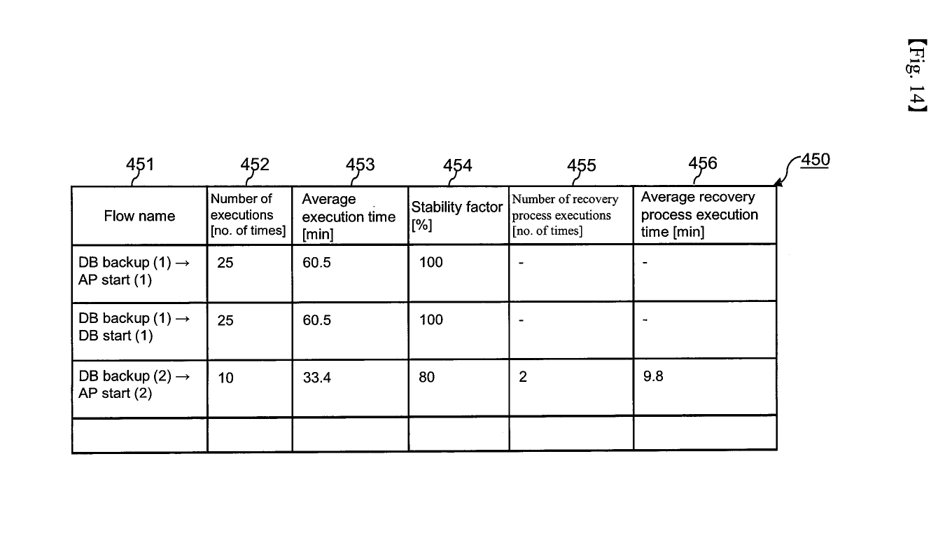

FIG. 14 is an example of the partial flow performance list 450. The partial flow performance list 450 tabulates and manages the performance for a plurality of task component combinations. The partial flow performance list 450, for example, includes a flow name 451, a number of executions 452, an average execution time 453, a stability factor 454, a number of recovery process executions 455, and an average recovery process execution time 456.

A partial flow name that makes it possible to ascertain the content of a task (task component) comprising a partial flow is registered in the flow name 451. A number of times that the partial flow was executed is registered in the number of executions 452. The average time required to complete the processing of all the tasks comprising the partial flow is registered in the average execution time 453.

A probability of all of a plurality of tasks comprising the partial flow ending normally is registered in the stability factor 454. A number of times that a recovery process was executed when any of the tasks comprising the partial flow ended abnormally is registered in the number of recovery process executions 455. An average time required to complete a recovery process executed when any of the tasks comprising the partial flow ended abnormally is registered in the average recovery process execution time 456.

The flow name 451, the number of executions 452, the average execution time 453, the stability factor 454, the number of recovery process executions 455, and the average recovery process execution time 456 are updated when a task component and a partial flow are retrieved. Updating may be performed at some other time.

The system administrator may update the partial flow performance list 450 at a predetermined time either manually, or using some sort of tool or utility program.

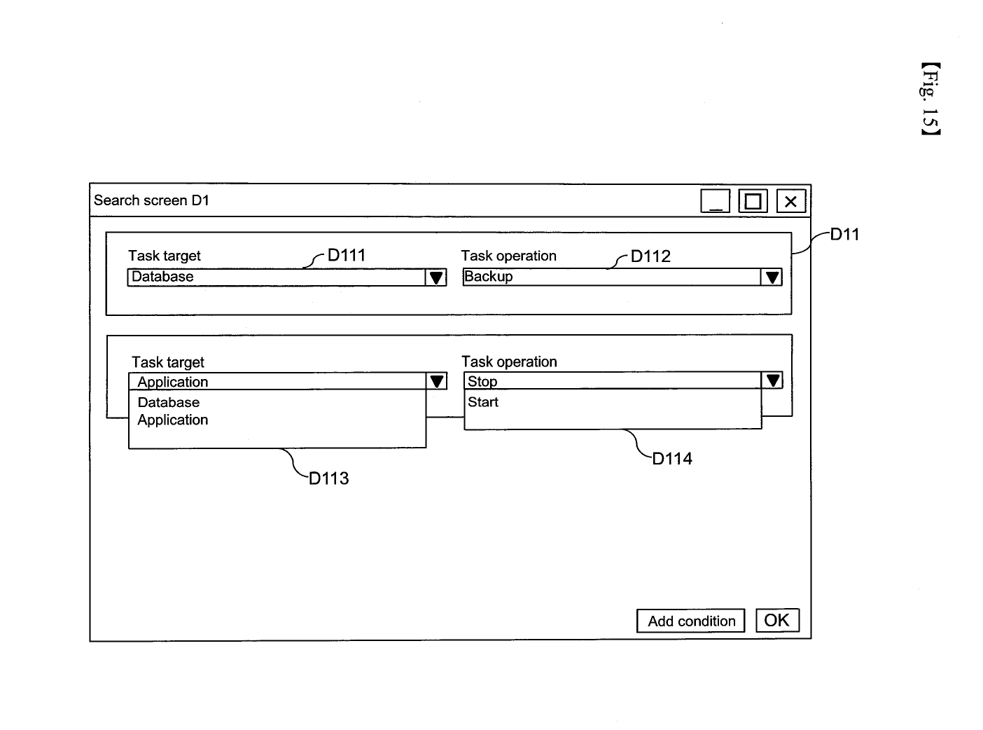

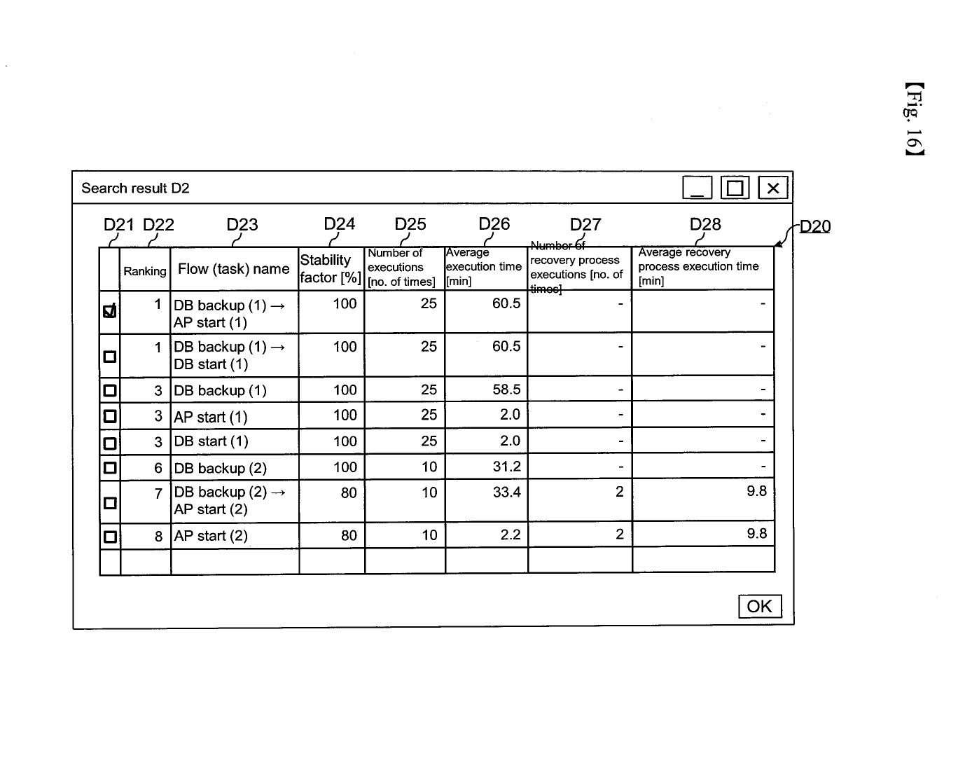

FIG. 15 is an example of the search keyword input screen D1 that is used when retrieving a task component and a partial flow. The search keyword input screen D1 is an example of a “condition specification screen”. The examples of screens in FIG. 15 and FIG. 16, which will be explained below, schematically illustrate a main display element and a button element. The present invention may use a screen comprising another configuration beside the screen configurations illustrated in FIGS. 15 and 16.

The search keyword input screen D1 includes one or more search conditions D11. A search condition D11, for example, includes a task target specification field D111, a task operation specification field D112, a task target candidate D113, and a task operation candidate D114.

A keyword related to the task target of a task component and a partial flow that the user wishes to retrieve is input to the task target specification field D111. A keyword related to an operation in relation to the task target of the task component and the partial flow that the user wishes to retrieve is input to the task operation specification field D112.

A keyword, which represents an input candidate of the task target specification field D111, is displayed in the task target candidate D113. The task target candidate D113 is associated with the task-target tag 422 in the task tag list 420 of FIG. 9.

A keyword, which represents an input candidate of the task operation specification field D112, is displayed in the task operation candidate D114. The task operation candidate D114 is associated with the task operation tag 423 in the task tag list 420 of FIG. 9.

FIG. 16 is an example of a search result screen D2, which is displayed after a task component and a partial flow have been retrieved.

The search result screen D2 includes a search results list D20. The search results list D20 displays search results in a list format.

The search results list D20, for example, includes a check field D21, a ranking D22, a partial flow name (or task component name) D23, a stability factor D24, a number of executions D25, an average execution time D26, a number of recovery process executions D27, and an average recovery process execution time D28.

A checkmark indicating a task component and a partial flow that the user wishes to obtain is configured in the check field D21.

A display order is displayed in ascending order from 1 in the ranking D22. A ranking, for example, is decided by determining whether the task component and the partial flow can be executed stably based on the stability factor D24 and/or the number of executions D25. Therefore, the ranking D22 can be used as a value (reliability evaluation value) indicating the reliability of the task component and the partial flow.

Either a partial flow name that makes it possible to ascertain the content of a task (task component) comprising the partial flow, or a name indicating the task content of the task component is displayed in the partial flow name (or task component name) D23.

Either a probability of all the task components comprising the partial flow ending normally, or a probability of the processing of one task component ending normally is displayed in the stability factor D24.

A number of times that the partial flow and the task component have been executed is displayed in the number of executions D25. Either an average value of the time required for the processing of all the task components comprising the partial flow to be completed, or an average value of the time required for the processing of a single task component to be completed is displayed in the average execution time D26.

Either a number of executions for the recovery process when any of the task components comprising the partial flow ended abnormally, or the number of executions of the recovery process when a single task component ended abnormally is displayed in the number of recovery process executions 455.

Either an average value of the time required to complete a recovery process executed when any of the task components comprising the partial flow ended abnormally, or an average value of the time required to complete a recovery process executed when a single task component ended abnormally is displayed in the average recovery process execution time 456.

The check field D21, the partial flow name (or task component name) D23, the stability factor D24, the number of executions D25, the average execution time D26, the number of recovery process executions D27, and the average recovery process execution time D28 are associated with the task name 441, the number of executions 442, the average execution time 443, the stability factor 444, the number of recovery process executions 445, and the average recovery process execution time 446 included in the task performance list 440 of FIG. 11, and with the flow name 451, the number of executions 452, the average execution time 453, the stability factor 454, the number of recovery process executions 455, and the average recovery process execution time 456 included in the partial flow performance list 450 of FIG. 12.

FIG. 17 is a flowchart illustrating an example of a series of processes by the management server 301 and the content management server 401.

First, the management server 301, when executing an automated operation flow, adds historical information on each task component comprising the automated operation flow to be executed to the task history list 350 (S1). Step S1 will be explained in detail below.

The content management server 401 collects the task history information 350 stored in the storage apparatus 312 of the management server 301, and creates an execution performance list 430 based on the task history list 350 (S2). Step S2 will be explained in detail below.

The content management server 401 retrieves a task component based on the search keyword input into the search keyword input screen D1, and acquires the execution performance information of the retrieved task component (S3). Step S3 will be explained in detail below.

The content management server 401, based on the execution performance information acquired in Step S3, respectively creates the task performance list 440 of the retrieved task component, and partial flow performance information 450 for the partial flow, which is a combination of task components (S4). Step S4 will be explained in detail below.

The content management server 401 creates a search result screen D2 based on the task performance list 440 and the partial flow performance list 450 created in Step S4, and outputs this search result screen D2 to a display apparatus capable of being used by the user (S5). Step S5 will be explained in detail below.

The content management server 401 retrieves from the contents list 480 either the task component or the partial flow checked by the user, and provides the contents to the management server 301 (S6). Step S6 will be explained in detail below.

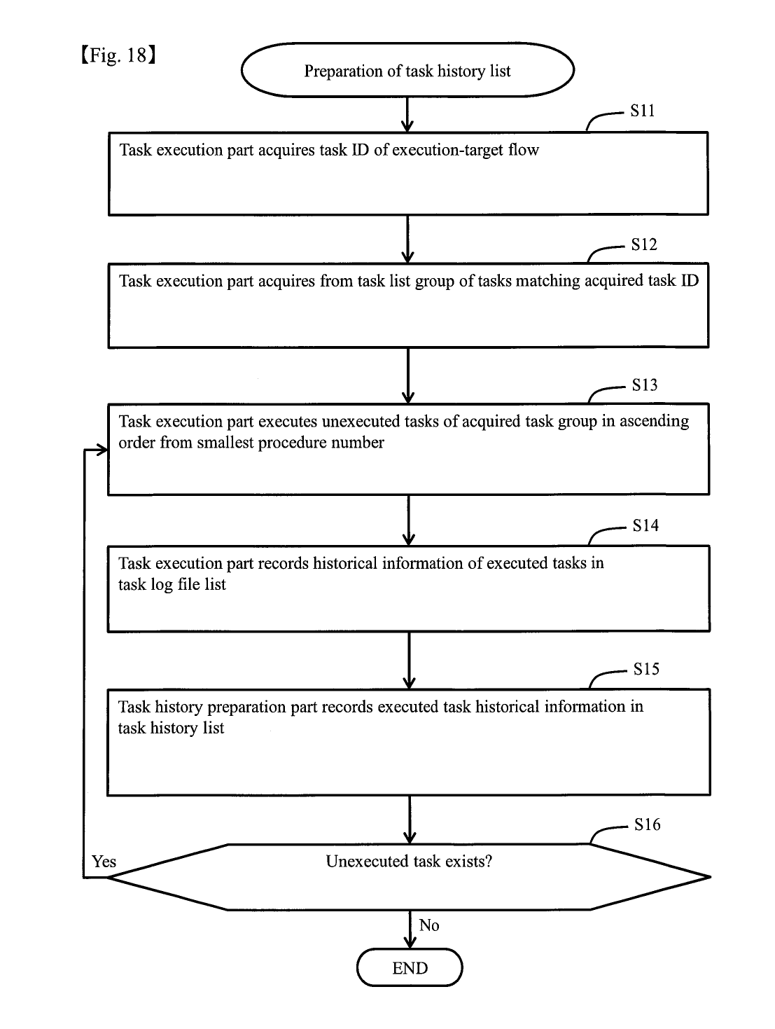

FIG. 18 is an example of a flowchart illustrating Step S1 of FIG. 17 in detail. This processing is executed by the management server 301.

The task execution part 302 references the flow list 320, and acquires the task ID 321 of the flow to be executed (S11).

The task execution part 302 references the task list 330, and acquires a group of task components that match the task ID 321 acquired in Step S11 (S12).

The task execution part 302 executes unexecuted task components among the group of task components acquired in Step S12 in order from the smallest procedure number (S13). The task execution part 302 references the previous procedure number 333 of the execution-target task component when executing the unexecuted task components.

When the processing of the task component, for which the previous procedure number 333 is regarded as the procedure number 332, is complete, the processing of the unexecuted task component is executed. In a case where the processing of the task component, for which the previous procedure number 333 is regarded as the procedure number 332, is not complete, the processing of the unexecuted task component does not start until the processing of the relevant task component is complete.

The task execution part 302 records the task start time, the task end time, the error status, the recovery process start time, the recovery process end time, and the task name of the task executed in Step S13 in the task log file list 340 (S14). The start of processing for a task component may be expressed as “task start”, and the end of processing for a task component may be expressed as “task end”.

The task history preparation part 303 references the task log file list 340, and records the task start time 341, the task end time 342, the error status 343, the recovery process start time 344, the recovery process end time 345, and the task name 346 of the task executed in Step S13 in the task history list 350 (S15).

The task execution part 302 checks whether an unexecuted task component exists among the task components comprising the executed automated operation flow (S16). When an unexecuted task component exists, the task execution part 302 returns to Step S13. When there are no unexecuted task components, the task execution part 302 ends the processing.

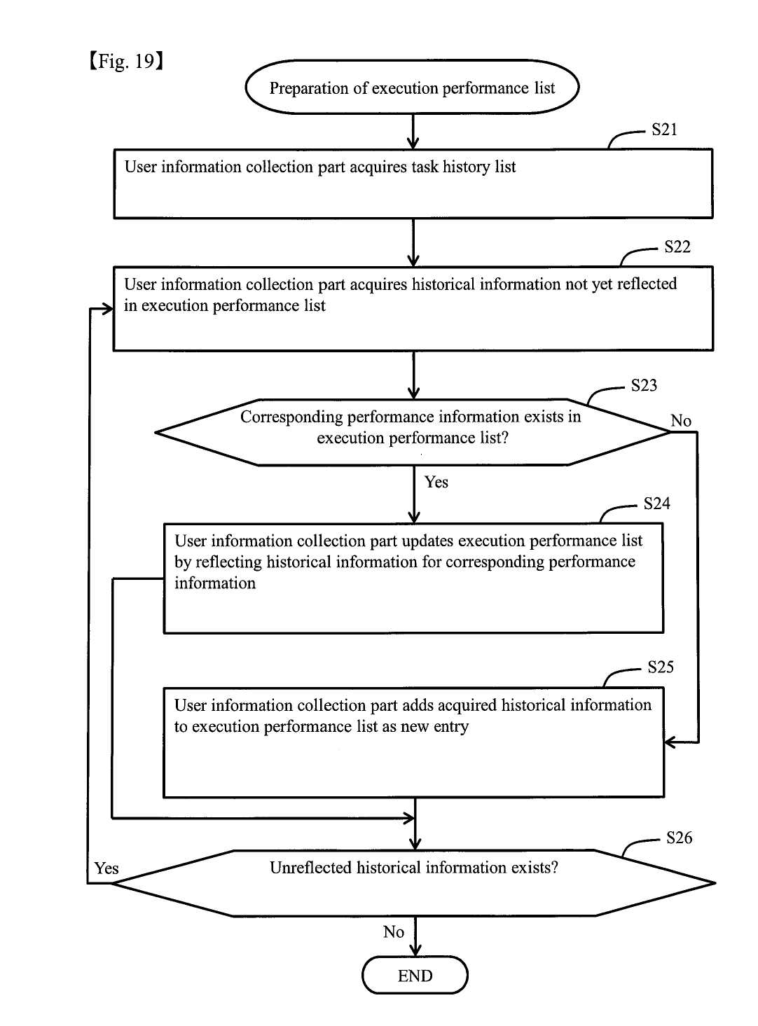

FIG. 19 is an example of a flowchart illustrating Step S2 of FIG. 17 in detail. This processing is executed by the content management server 401.

The user information collection part 402 acquires the task history list 350 from the management server 301 (S21). The user information collection part 402 acquires, from the task history list 350 acquired in Step S21, historical information that has yet to be reflected in the execution performance list 430 (S22).

The user information collection part 402 checks whether or not performance information corresponding to a combination of the task ID 351, the procedure number 352, and the previous procedure number 353 of the historical information acquired in Step S22 exists in the execution performance list 430 (S23).

When a corresponding combination of performance information exists, the processing advances to Step S24. When a corresponding combination of performance information does not exist, the processing advances to Step S25.

In a case where the processing has advanced to Step S24, the user information collection part 402 reflects the historical information acquired in Step S22 in the corresponding combination of performance information to update the execution performance list 430 (S24). Thereafter, the processing advances to Step S26.

In a case where the processing has advanced to Step S25, the user information collection part 402 records the historical information acquired in Step S22 in the execution performance list 430 as new information (S25). Thereafter, the processing advances to Step S26.

The user information collection part 402 checks whether historical information that has not been reflected in the execution performance information 430 exists among the task history information 350 acquired in Step S21 (S26). When unreflected historical information exists, the processing returns to Step S22. When unreflected historical information does not exist, the processing ends.

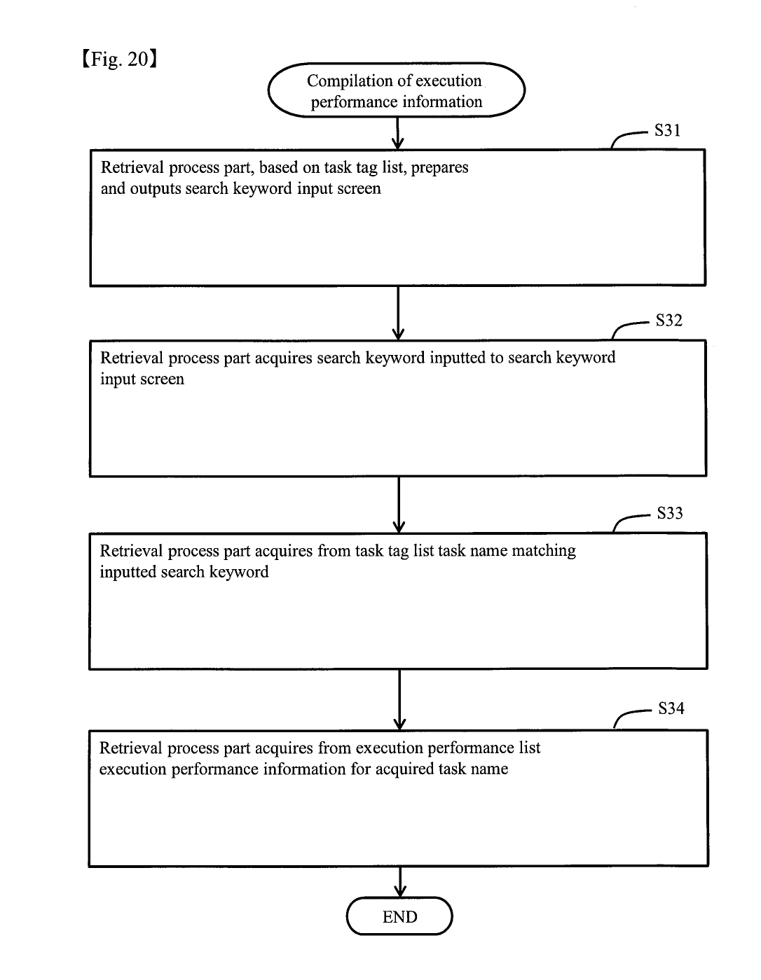

FIG. 20 is an example of a flowchart illustrating Step S3 of FIG. 17 in detail. This processing is executed by the content management server 401.

The retrieval process part 403 renders a search keyword input screen D1 based on the task tag list 420 and outputs this search keyword input screen D1 (S31). The task target candidate D113 of the search keyword input screen D1 is prepared based on the task-target tag 422. The task operation candidate D114 is prepared based on the task operation tag 423.

A search keyword is input to the search keyword input screen D1 (S32). The retrieval process part 403 references the task tag list 420, and acquires the task name 421 that matches the search keyword input in Step S32 (S33).

The retrieval process part 403 acquires, from the execution performance list 430, the execution performance information of the task name 421 acquired in Step S33 (S34).

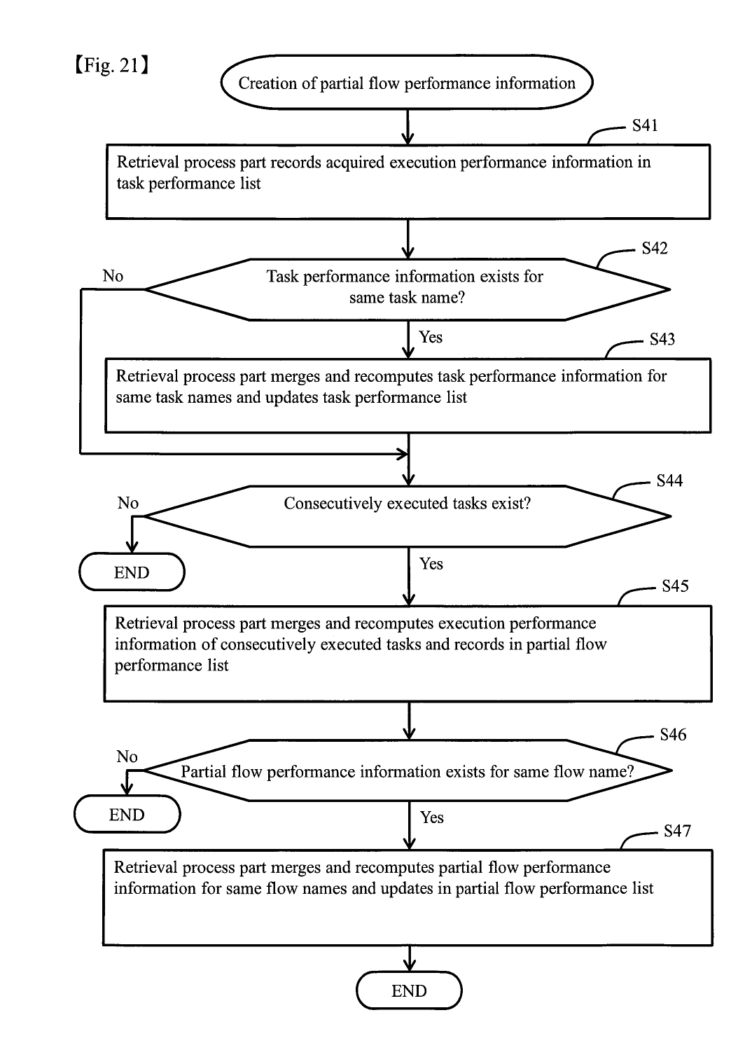

FIG. 21 is an example of a flowchart illustrating Step S4 of FIG. 17 in detail. This processing is executed by the content management server 401.

The retrieval process part 403 records the execution performance information acquired in Step S3 in the task performance list 440 (S41). The retrieval process part 403 checks whether task performance information of the same task name 441 exists in the task performance list 440 (S42). When this information exists, the processing advances to Step S43. When this information does not exist, the processing advances to Step S44.

In a case where the processing has advanced to Step S43, the retrieval process part 403 merges and recomputes the task performance information of the same task names 441 to update the task performance list 440 (S43).

In the case of number of executions, for example, the recomputation method takes the sum of the number of executions 442 of each piece of task performance information to be merged. For example, in the case of the average execution time, the recomputation method takes the sum of the total execution time of each piece of task performance information to be merged (multiplies the number of executions 442 by the average execution time 443), and divides this sum by the sum of the number of executions 442. Recomputation may be performed using some other method.

The retrieval process part 403 checks whether a consecutively executed task (task component) exists among the execution performance information acquired in Step S3 (S44). For example, a confirmation method in a case where execution performance information A and execution performance information B exist will be explained. In a case where the task ID 431 of the execution performance information A and the task ID 431 of the execution performance information B correspond, and, in addition, either the procedure number 432 of the execution performance information A and the previous performance number of the execution performance information B correspond, or the procedure number 432 of the execution performance information B and the previous performance number of the execution performance information A correspond, it is determined that the execution performance information A and the execution performance information B are consecutively executed tasks. This determination may be made using some other method.

When consecutively executed tasks exist, the processing advances to Step S45. When consecutively executed tasks do not exist, the processing ends.

In a case where the processing has advanced to Step S45, the retrieval process part 403 merges and recomputes the execution performance information of the consecutively executed tasks, and records this information in the partial flow performance list 450 (S45). In the case of number of executions, for example, the recomputation method compares the number of executions of the execution performance information to be merged and uses the number of executions having a small value as the number of executions 452. This recomputation may be performed using some other method.

The retrieval process part 403 checks whether partial flow performance information of the same flow name 451 exists in the partial flow performance list 450 (S46). When this information exists, the processing advances to Step S47. When this information does not exist, the processing ends.

In a case where the processing has advanced to Step S47, the retrieval process part 403 merges and recomputes the partial flow performance information having the same flow names 451 to update the partial flow performance list 450 (S47). The recomputation method is the same as that described in the explanation of Step S43.

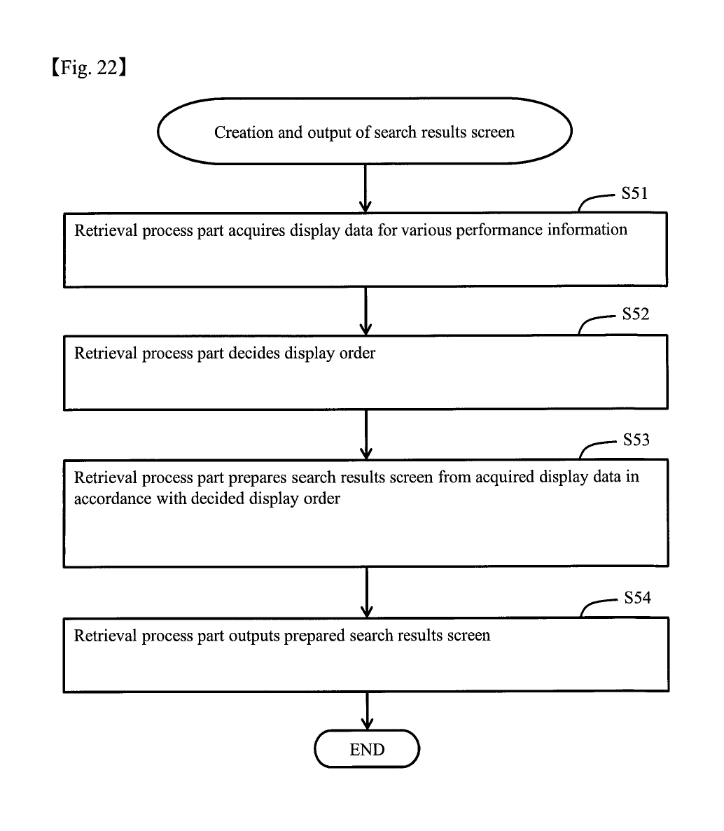

FIG. 22 is an example of a flowchart illustrating Step S5 of FIG. 17 in detail. This processing is executed by the content management server 401.

The retrieval process part 403 acquires display data for each type of performance information in the task performance list 440 and the partial flow performance list 450 created in Step S4 (S51).

The retrieval process part 403 configures a ranking D22 based on the stability factor, the number of executions, and the average execution time of each type of performance information, and decides a display order (S52).

The ranking D22, for example, can be configured in accordance with either all or a portion of the criteria for displaying the data in descending order from the largest stability factor value, displaying the data in descending order from the largest number of executions value, displaying the partial flow above a single task component, and displaying the data in ascending order from the smallest average execution time value. This configuration may be made using some other method.

A task component or a partial flow having a large stability factor value, and a task component or a partial flow having a large number of executions value can be considered a reliable task component or partial flow. Displaying the partial flow above a single task component is done to simplify a user selection operation. Selecting a partial flow, which is a combination of a plurality of task components, rather than selecting all of the required task components individually one at a time can save the user time and trouble in this operation.

The retrieval process part 403, in accordance with the display order decided in Step S52, renders a search result screen D2 based on the display data acquired in Step S51 (S53). The retrieval process part 403 outputs the search result screen D2 rendered in Step S53 (S54). The search result screen D2, for example, is displayed on the input/output apparatus 311 of the management server 301.

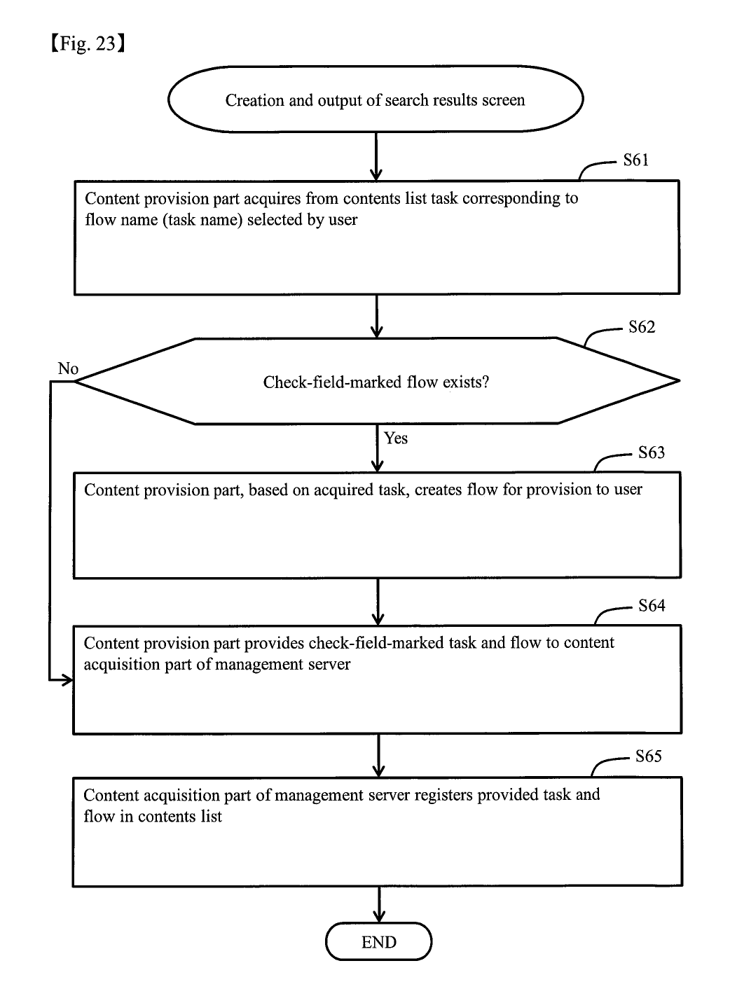

FIG. 23 is an example of a flowchart illustrating Step S6 of FIG. 17 in detail. One portion of this processing is executed by the management server 301, and the other portion of this processing is executed by the content management server 401.

The content provision part 404 retrieves and acquires a task from the contents list 480 based on the flow name (task component name) D23 of either the task component or the partial flow which has a checkmark entered in the check field D21 (S61).

The content provision part 404 checks whether there is a partial flow for which a checkmark has been entered in the check field D21 (S62). When a checked partial flow exists, the processing advances to Step S63. When a checked partial flow does not exist, the processing advances to Step S64.

In a case where the processing has advanced to Step S63, the content provision part 404, based on the task component acquired in Step S61, creates a partial flow to be provided (S63). The content provision part 404 provides the task component and the partial flow for which the checkmark has been entered in the check field D21 to the content acquisition part 304 of the management server 301 (S64).

The content acquisition part 304 registers the task component and the partial flow provided in Step S64 in the contents list 380 (S65).

In this example, which is configured like this, the content management server 401 manages an automated operation flow executed by the management server 301 by acquiring the execution result, and, in addition, retrieves a task component in accordance with a request from the management server 301 and provides the task component to the management server 301.

The content management server 401 can uniquely manage the results of the automated operation flows respectively executed by a plurality of management servers 301, and can store the execution performance of the task component to respond to a new retrieval request from the management server 301.

Therefore, the user of a content provision service can prepare a desired automated operation flow in a relatively short time by querying the content management server 401 and obtaining an appropriate task component, and heighten the efficiency of an operation management task, thereby enhancing usability.

In this example, when a task component candidate is presented to the management server 301, the execution performance of this task component candidate is also presented. Therefore, the user can take the execution performance into consideration and select a task component believed to be appropriate from among a large number of task component candidates, thereby heightening usability.

In this example, not only is a single task component presented to the management server 301, but a combination (partial flow) of a plurality of task components that have been executed consecutively is also presented the management server 301. Therefore, the user is not only able to select individual task components one at a time, but is also able to select a plurality of task components at one time. This makes it possible to shorten the preparation time for an automated operation flow, thereby heightening usability.

In this example, a partial flow is presented to the management server 301 together with the execution performance for this partial flow. Thus, the user is able to select a partial flow on the basis of the execution performance, making for ease of use.

In this example, a stability factor is calculated for a task component and a partial flow on the basis of the performance history, and this stability factor is presented to the management server 301. Thus, the user can take the stability factor into consideration to obtain a task component and a partial flow with higher reliability. Therefore, it is possible to prepare a highly reliable automated operation flow in a relatively short time.

In this example, the presence or absence of an error occurrence can be included in the execution results for a task component and a partial flow. Therefore, the user can select a task component and a partial flow by taking into consideration the past error status.

In this example, information indicating the existence of a recovery process that is started when an error has occurred can be presented together with the task component and the partial flow when they are presented. Therefore, the user is able to construct a highly stable system by selecting a task component for which a recovery process has been prepared just in case an error should occur. In addition, by making use of a task component for which a recovery process has been prepared, the user does not need to prepare a recovery process on his own, thereby making it possible to prepare a highly stable automated operation flow that much quicker.

### Example 2

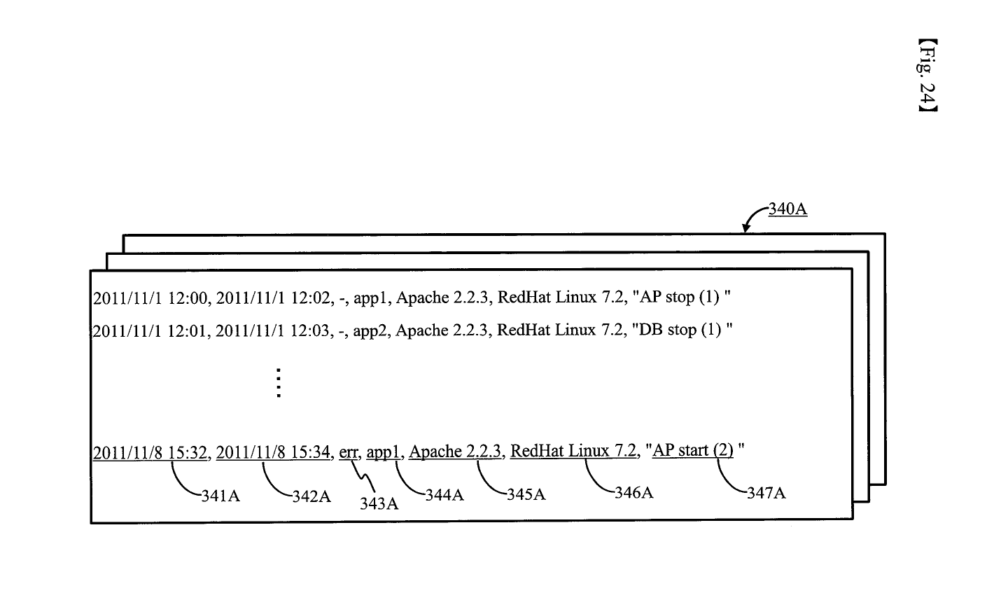

A second example will be explained by referring to FIGS. 24 through 37. This example corresponds to a variation of the first example, and comprises a configuration in common with the first example. Accordingly, the following explanation will focus on the differences with the first example. In this example, when retrieving a task component for realizing a predetermined function, the extent to which the task component matches up with the execution environment (for example, the software configuration and/or the hardware configuration) is also taken into consideration. This makes it possible for the user to select a more appropriate task component in accordance with the actual environment.

The overall system configuration (FIG. 1), the system configuration of the operation management systems 102 and 103 (FIG. 2), the configuration of the management server 301 (FIG. 3), the configuration of the content management server 401 of the content provision system 101 (FIG. 4), the data flow (FIG. 5), the flow list 320 details (FIG. 6), the task list 330 details (FIG. 7), the contents list 380 details (FIG. 10), and the task tag list (FIG. 11) are shared in common with the first example.

FIG. 24 is an example of a task log file list 340A in the second example. The task log file list 340A includes at least one task log file.

The task log, for example, includes a task start time 341A, a task end time 342A, an error status 343A, a task-target application name 344A, a task-target middleware name 345A, a task-target OS name 346A, and a task name 347A.

The task start time 341A includes the date and time at which the execution of a task started. The task end time 342A includes the date and time at which the execution of the task ended. The error status 343A indicates whether or not the task ended normally. A “−” signifies a normal end, and “err” signifies an abnormal end.

The task-target application name 344A indicates the name of the application targeted by the task in the operation-target host. The task-target middleware name 345A indicates the name of the middleware targeted by the task in the operation-target host. The task-target OS name 346A indicates the name of the OS in the task-target host. The task name 347A indicates the executed task content, and is a name that is unique identification information.

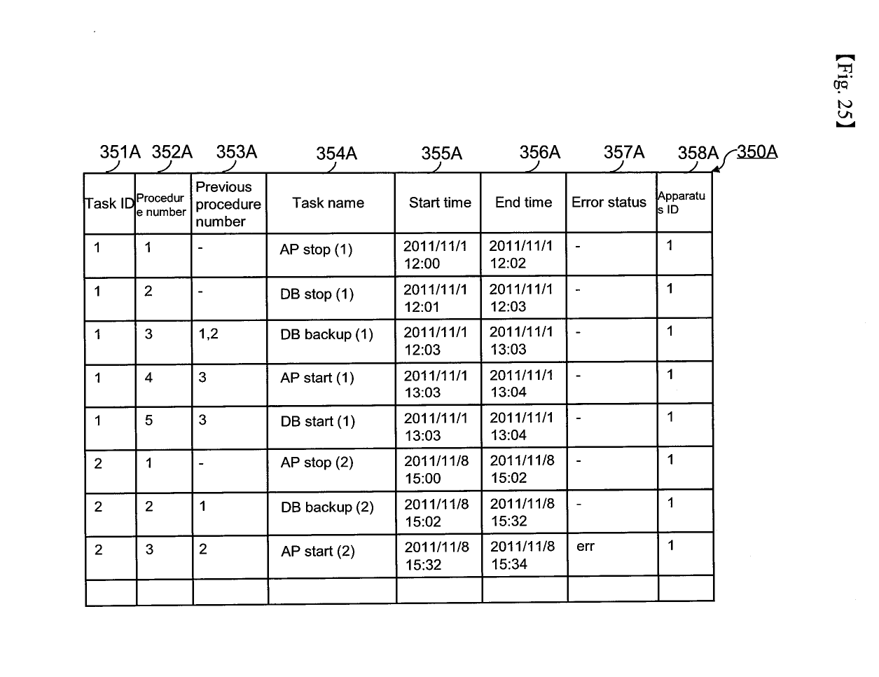

FIG. 25 is an example of the task history list 350A. The task history list 350A, for example, includes a task ID 351A, a procedure number 352A, a previous procedure number 353A, a task name 354A, a start time 355A, an end time 356A, an error status 357A, and an apparatus ID 358A.

The same identification information as that of the automated operation flow corresponding to each task component is registered in the task ID 351A. The same identification information as that of the task order in the automated operation flow corresponding to each task component is registered in the procedure number 352A.

The procedure number 352A of another task component the execution of which must be completed before a certain task component is executed, in the plurality of task components that comprises an automated operation flow, is registered in the previous procedure number 353A.

A name that uniquely identifies the task content is registered in the task name 354A. The date and time at which the execution of the task started is registered in the start time 355A. The date and time at which the execution of the task ended is registered in the end time 356A. Information as to whether or not the processing of the task component ended normally is registered in the error status 357A. A “−” signifies a normal end, and “err” signifies an abnormal end.

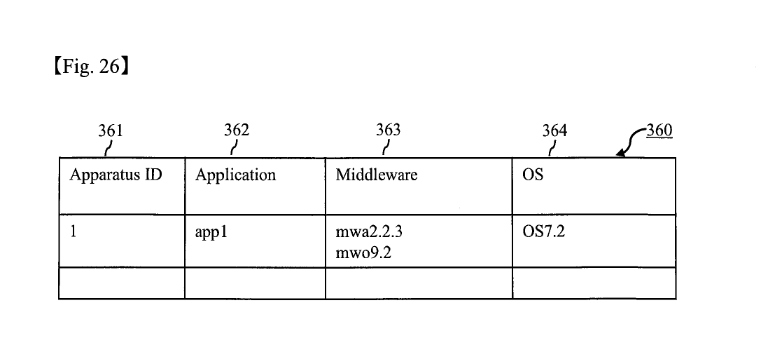

Unique identification information associated with detailed task-target information is registered in the apparatus ID 358A. The apparatus ID 358A is linked to the apparatus ID list 360 of FIG. 26, which will be explained below.

FIG. 26 is an example of the apparatus ID list 360. The apparatus ID list 360, for example, includes an apparatus ID 361, an application 362, a middleware 363, and an OS 364.

Information for identifying detailed task-target information related to a task component associated with the apparatus ID 361 is registered in the apparatus ID 361.

An application name targeted by the task component associated with the apparatus ID 361 is registered in the application 362. A middleware name targeted by the task component associated with the apparatus ID 361 is registered in the middleware 363. An OS name targeted by the task component associated with the apparatus ID 361 is registered in the OS 364. The apparatus ID list 460 in the content management server 401 has the same configuration as that described above, and as such, an explanation of the apparatus ID list 460 will be omitted.

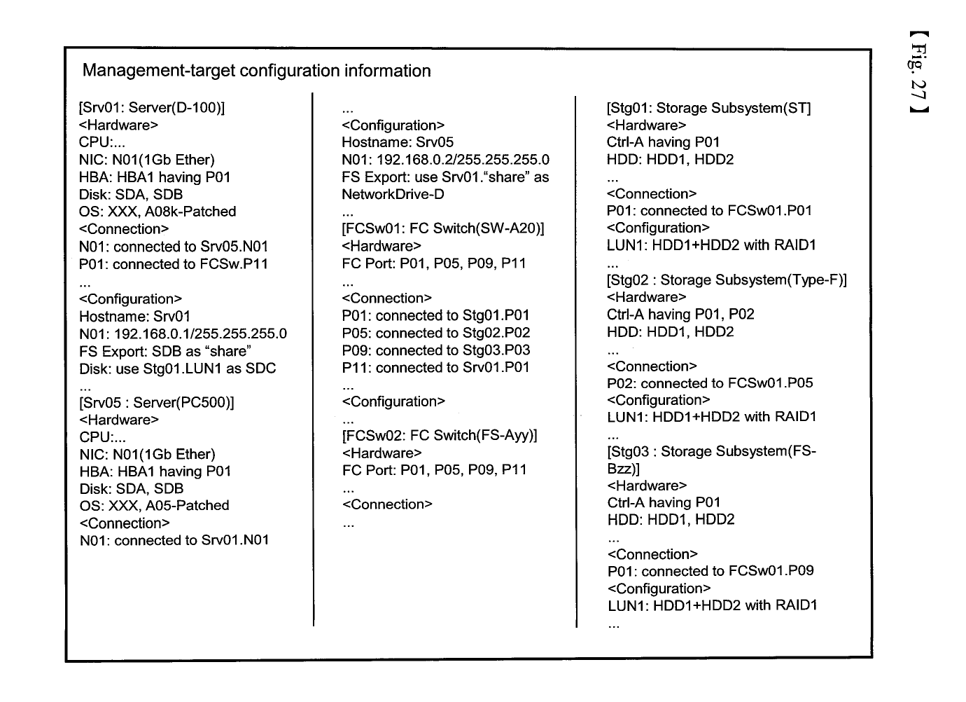

FIG. 27 is an example of a configuration information list 370. The configuration information list 370, for example, can include connection-related information for a server apparatus 203, a network apparatus 204, and a storage apparatus 205 included in a management-target system, information related to the processor and main memory of each apparatus, and information related to the software installed in each apparatus. The configuration may be such as to include all of the connection-related information, the hardware component information, and the software component information, or the configuration may be such as to not include any one thereof. A configuration information list 470 in the content management server 401 is the same configuration as described above, and as such, an explanation of the configuration information list 470 will be omitted.

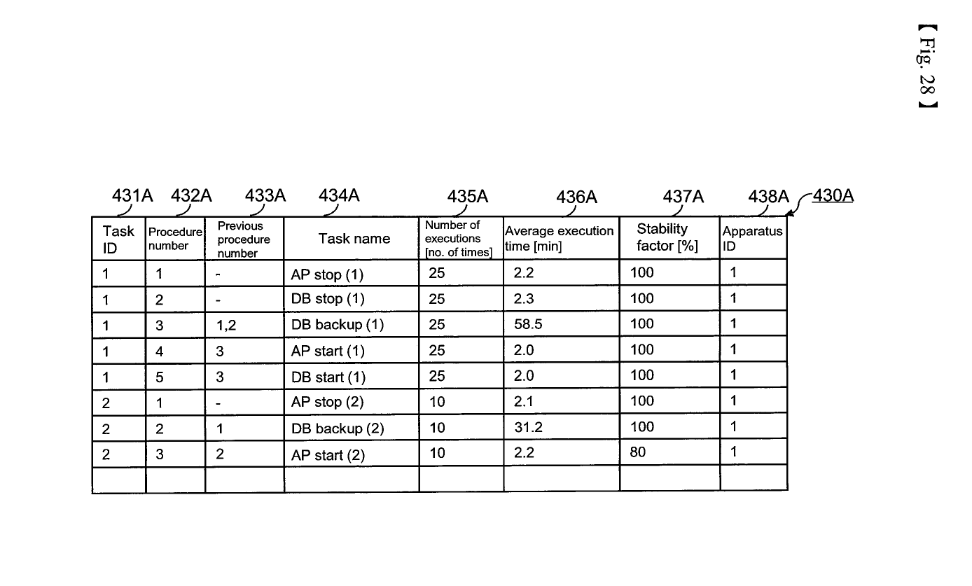

FIG. 28 is an example of an execution performance list 430A. The execution performance list 430A, for example, includes a task ID 431A, a procedure number 432A, a previous procedure number 433A, a task name 434A, a number of executions 435A, an average execution time 436A, a stability factor 437A, and an apparatus ID 438A.

The same identification information as that of the automated operation flow corresponding to each task component is registered in the task ID 431A. The same identification information as that of a task order in the automated operation flow corresponding to each task component is registered in the procedure number 432A.

The procedure number 432A of another task component the execution of which must be completed before a certain task component is executed, in a plurality of task components that comprises an automated operation flow, is registered in the previous procedure number 433A.

A name for uniquely identifying the task content is registered in the task name 434A. The number of times that the processing for the task component was executed is registered in the number of executions 435A. The average time required to complete the processing of the task components is registered in the average execution time 436A. A probability of the processing of the task component ending normally is registered in the stability factor 437A. Unique identification information associated with detailed task-target information is registered in the apparatus ID 438A.

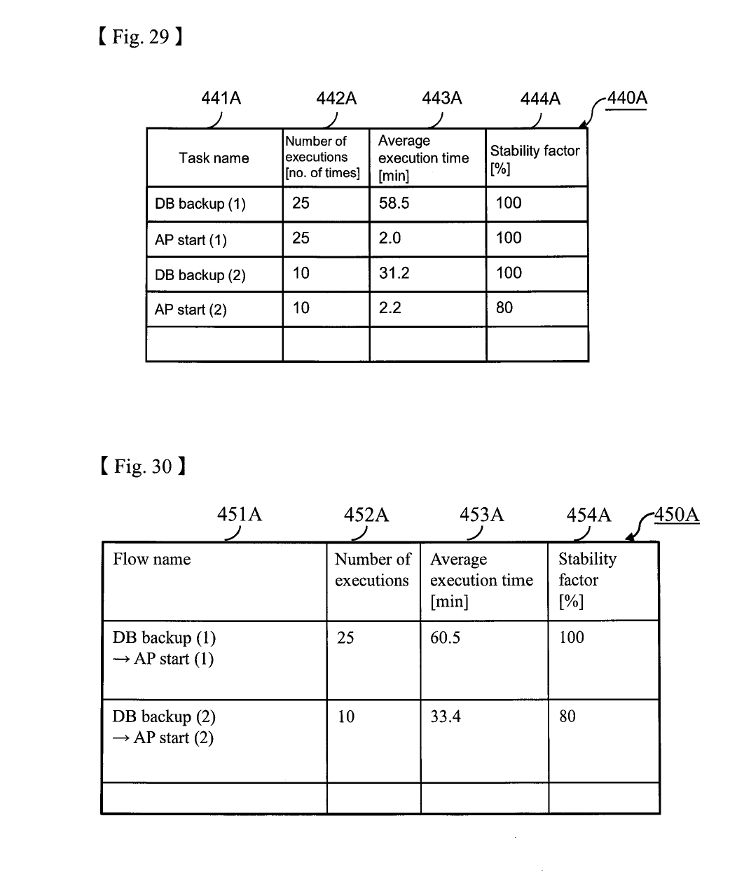

FIG. 29 is an example of a task performance list 440A. The task performance list 440A, for example, includes a task name 441A, a number of executions 442A, an average execution time 443A, and a stability factor 444A.

A name for uniquely identifying the task content is registered in the task name 441A. A number of times that the processing for the task component was executed is registered in the number of executions 442A. An average time required to complete the processing of the task components is registered in the average execution time 443A. A probability of the processing of the task component ending normally is registered in the stability factor 444A.

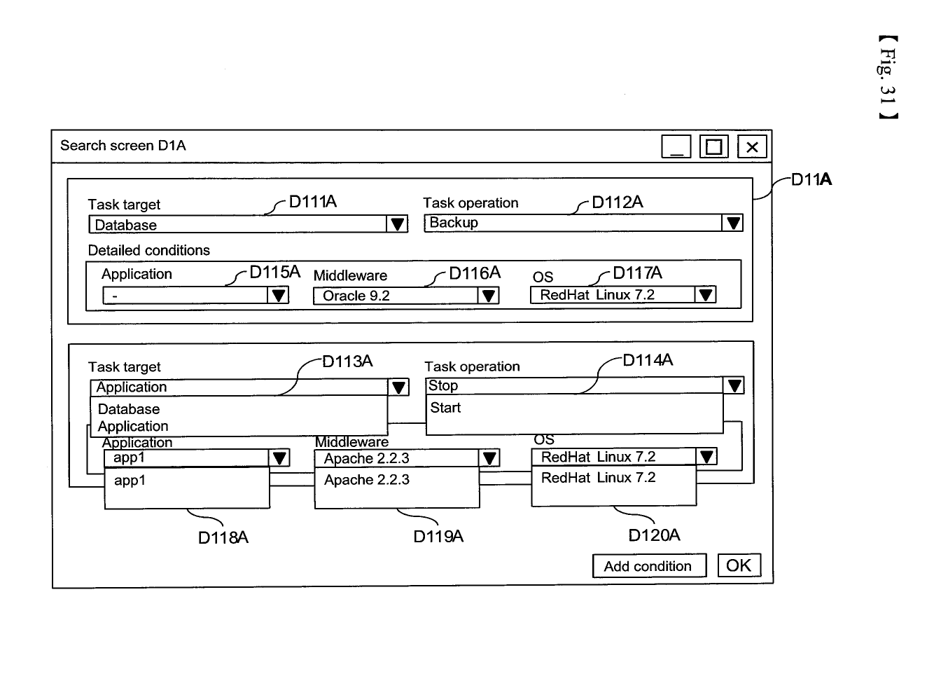

FIG. 30 is an example of a partial flow performance list 450A. The partial flow performance list 450A, for example, includes a flow name 451A, a number of executions 452A, an average execution time 453A, and a stability factor 454A.

A partial flow name that makes it possible to ascertain the content of a task component comprising a partial flow is registered in the flow name 451A. A number of times that the partial flow was executed is registered in the number of executions 452A. An average time required to complete the processing of all the task components comprising the partial flow is registered in the average execution time 453A. A probability of all of the task components comprising the partial flow ending normally is registered in the stability factor 454A.

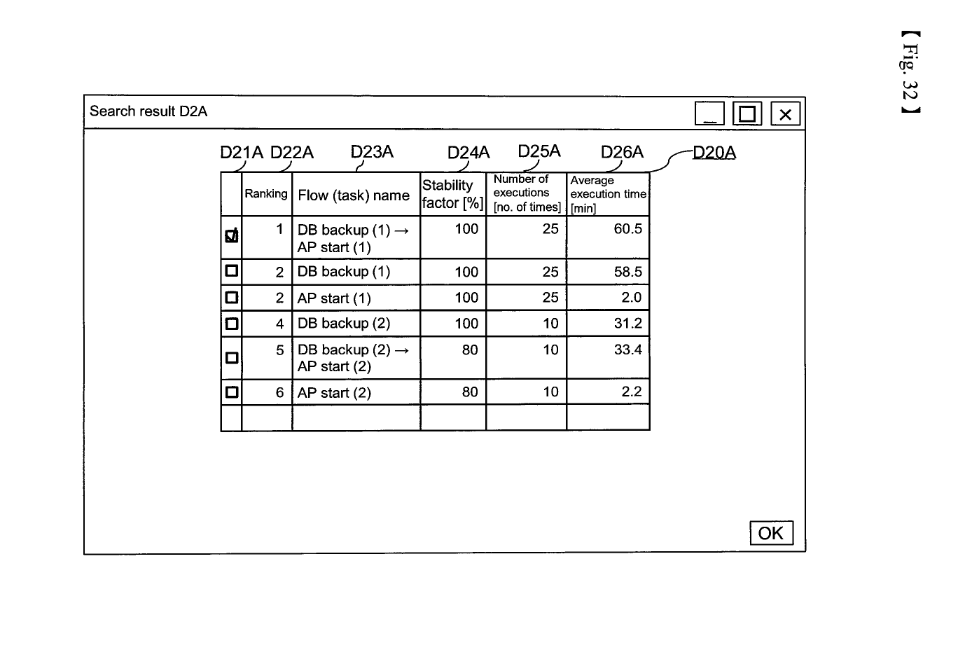

FIG. 31 is an example of a search keyword input screen D1A for performing input when retrieving a task component and a partial flow.

The search keyword input screen D1A includes a search condition D11A. The search keyword input screen D1A comprises one or more search conditions D11A. The search condition D11A, for example, includes a task target specification field D111A, a task operation specification field D112A, a task target candidate D113A, an a task operation candidate D114A, an application specification field D115A, a middleware specification field D116A, an OS specification field D117A, an application candidate D118A, a middleware candidate D119A, and an OS candidate D120A.

A keyword related to a task target of a task component and a partial flow is input to the task target specification field D111A. A keyword related to an operation on the task target by the task component and the partial flow is input to the task operation specification field D112A.

A keyword, which represents an input candidate of the task target specification field D111A, is displayed in the task target candidate D113A. The task target candidate D113A is associated with the task-target tag 422 in the task tag list 420 of FIG. 9.

A keyword, which represents an input candidate of the task operation specification field D112A, is displayed in the task operation candidate D114A. The task operation candidate D114A is associated with the task operation tag 423 in the task tag list 420 of FIG. 9.

The name of the application that represents the task target of the task component and the partial flow is input to the application specification field D115A. The name of the middleware that represents the task target of the task component and the partial flow is input to the middleware specification field D116A. The name of the OS that represents the task target of the task component and the partial flow is input to the OS specification field D117A.

The name of the application that represents the input candidate of the application specification field D115A is displayed in the application candidate D118A. The application candidate D118A is associated with the application 362 of the apparatus ID list 360 of FIG. 26.

The name of the middleware that represents the input candidate of the middleware specification field D116A is displayed in the middleware candidate D119A. The middleware candidate D119A is associated with the middleware 363 of the apparatus ID list 360 of FIG. 26.

The name of the OS that represents the input candidate of the OS specification field D117A is displayed in the OS candidate D120A. The OS candidate D120A is associated with the OS 364 of the apparatus ID list 360 of FIG. 26.

FIG. 32 is an example of a search result screen D2A displayed after a task component and a partial flow have been retrieved. The search result screen D2A includes a search results list D20A. The search results list D20A is a table format, and comprises one or more rows. The search results list D20A, for example, includes a check field D21A, a ranking D22A, a partial flow name (or task component name) D23A, a stability factor D24A, a number of executions D25A, and an average execution time D26A.

A checkmark for a task component and a partial flow that the user wishes to obtain is input in the check field D21A. A ranking calculated based on the stability factor D24A and the number of executions D25A is displayed in the ranking D22A. The ranking is an index for determining whether the task component and the partial flow can be executed stably, and is assigned to the most stable task component and partial flow in ascending order beginning from 1.

Either a partial flow name that makes it possible to ascertain the content of a task comprising the partial flow, or a name indicating the task content of the task component is displayed in the partial flow name (or task component name) D23A.

Either a probability of all the processing for the task components comprising the partial flow ending normally, or a probability of the processing of one task component ending normally is displayed in the stability factor D24A. A number of times that the partial flow and the task component have been executed is displayed in the number of executions D25A. Either an average value of the time required for the processing of all the task components comprising the partial flow to be completed, or an average value of the time required for the processing of a single task component to be completed is displayed in the average execution time D26A.

The partial flow name (or task component name) D23A, the stability factor D24A, the number of executions D25A, and the average execution time D26A are associated with the task name 441A, the number of executions 442A, the average execution time 443A, and the stability factor 444A included in the task performance list 440A of FIG. 29, and with the flow name 451A, the number of executions 452A, the average execution time 453A, and the stability factor 454A included in the partial flow performance list 450A of FIG. 30.

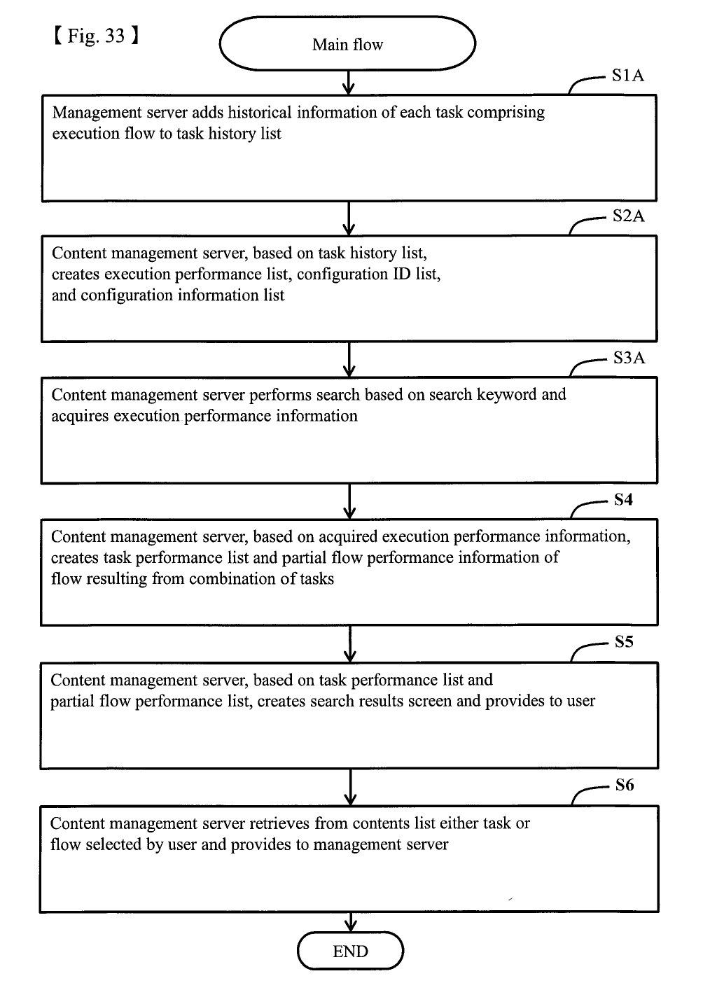

FIG. 33 is a flowchart of a series of processes by the management server 301 and the content management server 401.

The management server 301, when executing an automated operation flow, adds historical information on each task component comprising the automated operation flow to the task history list 350 (S1A). Step S1A will be explained in detail below.

The content management server 401 collects the task history list 350, the configuration ID list 360, and the configuration information list 370 stored in the storage apparatus 312 of the management server 301, and based on the collected information, creates an execution performance list 430, a configuration ID list 460, and a configuration information list 470 (S2A). Step S2A will be explained in detail below.

The content management server 401 retrieves a task component based on the search keyword input into the search keyword input screen D1A, and acquires the execution performance information of the retrieved task (S3A). Step S3A will be explained in detail below.

The content management server 401, based on the execution performance information acquired in Step S3A, creates the task performance list 440 of the retrieved task component, and the partial flow performance information 450 for the partial flow, which is a combination of task components (S4A). Step S4A will be explained in detail below.

Step S5A and Step S6A executed thereafter are the same as Step S5 and Step S6 described in the first example. The details are as described in the explanation of FIG. 17.

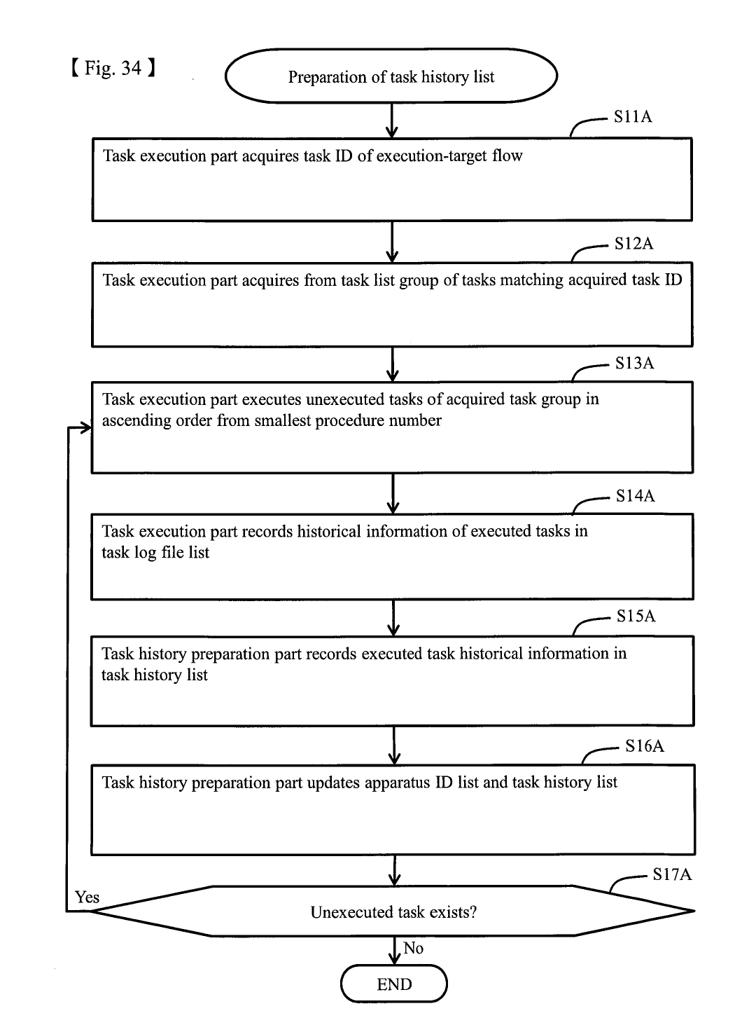

FIG. 34 is an example of a flowchart illustrating Step S1A of FIG. 33 in detail. This processing is executed by the management server 301.

Step S11A through Step S14A are the same as Steps S11 through S14 of the first example. The details are as described in the explanation of FIG. 18.

The task history preparation part 303 references the task log file list 340, and records the task start time 341A, the task end time 342A, the error status 343A, and the task name 347A of the task component executed in S13A in the task history list 350 (S15A).

The task history preparation part 303 references the task log file list 340, acquires the application name 344A, the middleware name 345A, and the OS name 346A, which are the task targets, records this information in the apparatus ID list 360, and, in addition, records the apparatus ID 361 in the task history list 350 (S16A). Step S16A will be explained in detail below.

The task execution part 302 checks whether an unexecuted task component exists among the task components comprising the executed automated operation flow (S17A). When an unexecuted task component exists, the processing returns to Step S13A. When an unexecuted task component does not exist, the processing of Step S1A ends.

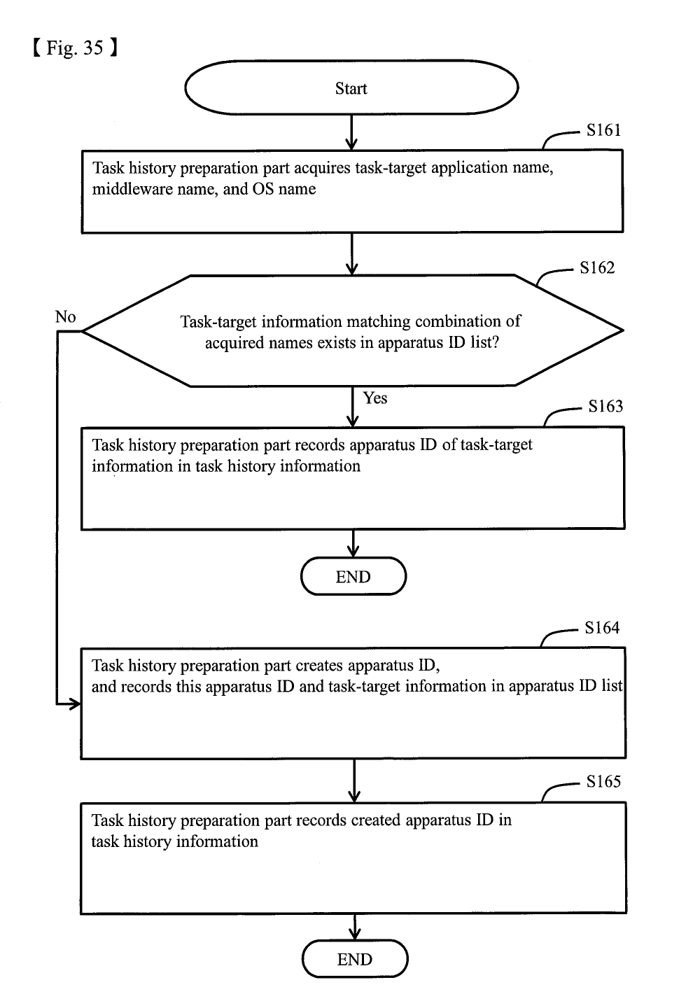

FIG. 35 is an example of a flowchart illustrating Step S16A of FIG. 34 in detail. This processing is executed by the management server 301.

The task history preparation part 303 acquires, from the task log file list 340A, the application name 344A, the middleware name 345A, and the OS name 346A, which are the task targets (S161). The task history preparation part 303 checks whether task target information matching the combination of information acquired in Step S161 is in the apparatus ID list 360 (S162). When this information exists, the processing advances to Step S163. When this information does not exist, the processing advances to Step S164.

When the processing has advanced to Step S163, the task history preparation part 303 acquires the apparatus ID 361 of the matching task target information, and records the apparatus ID 361 in the apparatus ID 438A of the task target information (S163). Thereafter, the processing for this process ends (Step S16A).

When the processing has advanced to Step S164, the task history preparation part 303 creates a unique apparatus ID, and records the task target information acquired in Step S161 together with the created apparatus ID in the apparatus ID list 360 (S164).

The task history preparation part 303 records the apparatus ID created in Step S164 in the apparatus ID 438A of the task history information (S165). Thereafter, this processing ends.

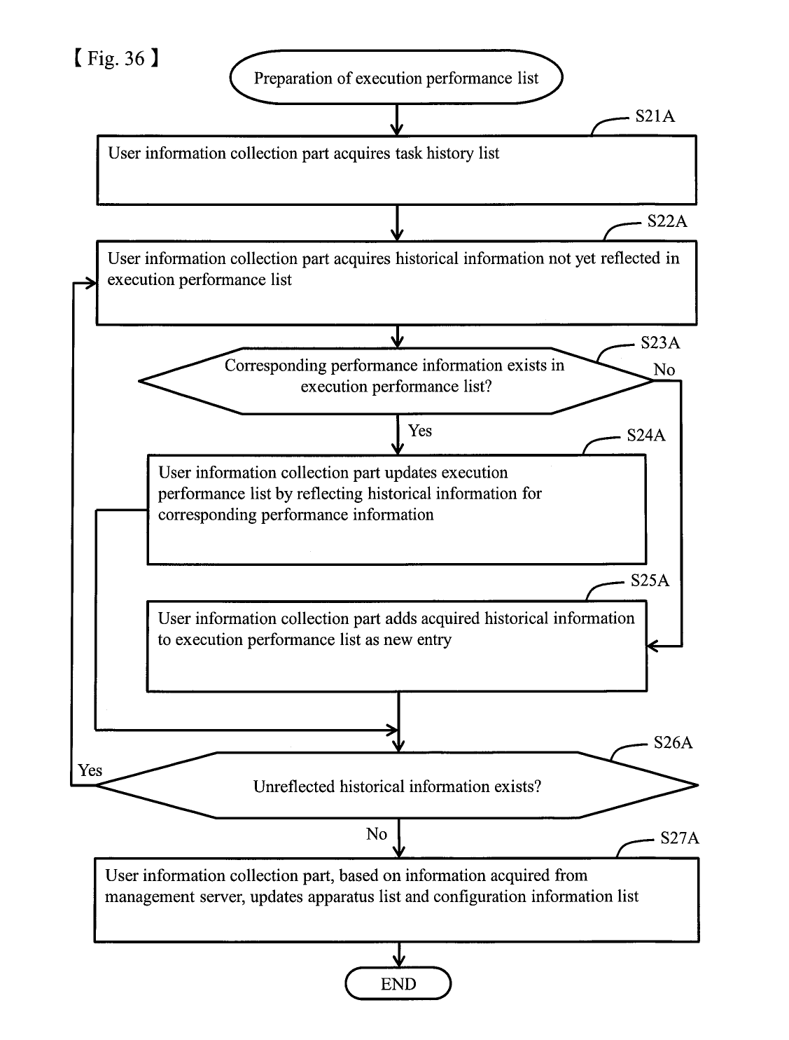

FIG. 36 is an example of a flowchart illustrating Step S2A of FIG. 33 in detail. This processing is executed by the content management server 401.

Step S21A through Step S26A are the same as Steps S21 through S26 of the first example. The details are as described in the explanation of FIG. 19.

The user information collection part 402 acquires the apparatus ID list 360 and the configuration information list 370 from the management server 301, and records these lists 360 and 370 in the apparatus ID list 460 and the configuration information list 470 (S27A). Thereafter, this processing ends (Step S2A).

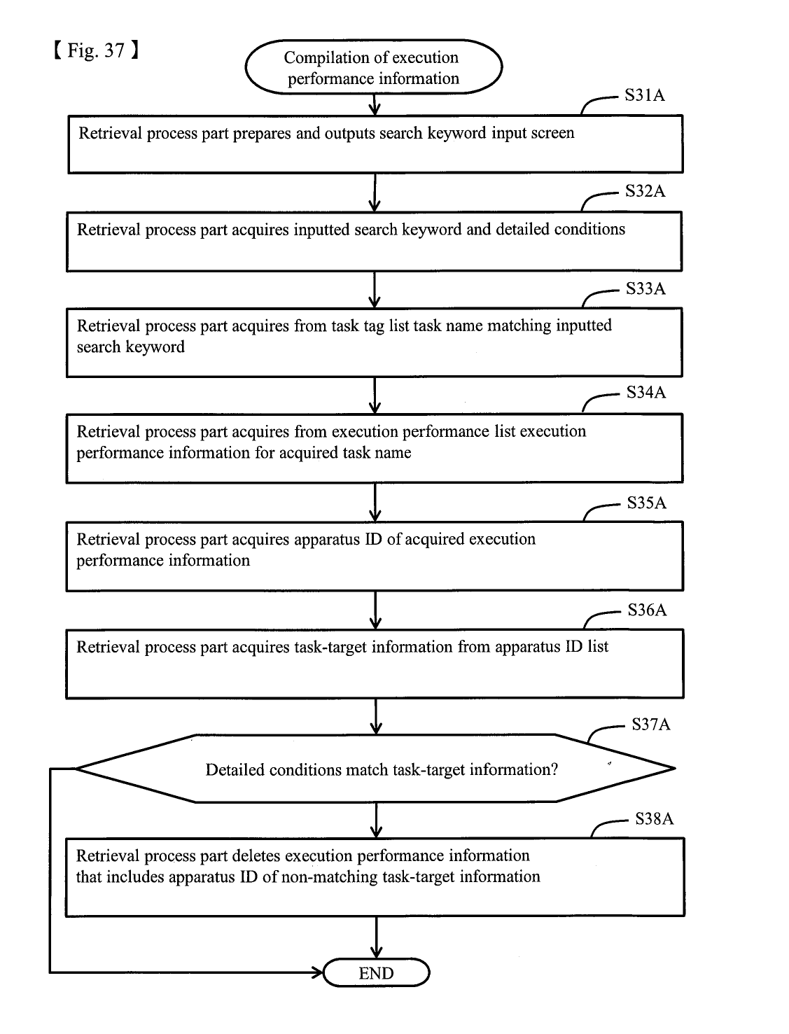

FIG. 37 is an example of a flowchart illustration Step S3A of FIG. 33 in detail. This processing is executed by the content management server 401.

The retrieval process part 403 renders a search keyword input screen D1A based on the task tag list 420 and the configuration information list 470, and outputs the input screen D1A to the output apparatus of the management server 301 (input/output apparatus 311) (S31A).

The retrieval process part 403 receives a search keyword and a detailed condition input to the search keyword input screen D1A by the user (S32A). The retrieval process part 403 references the task tag list 420 and acquires the task name 421 that matches the search keyword input in Step S32A (S33A).

The retrieval process part 403 acquires the execution performance information of the task name 421 acquired in Step S33A from the execution performance list 430 (S34A). The retrieval process part 403 acquires the apparatus ID 438A of the execution performance information acquired in Step S34A (S35A).

The retrieval process part 403 references the apparatus ID 461 of the apparatus ID list 460 and acquires task target information that matches the apparatus ID 438A acquired in Step S35A (S36A). The retrieval process part 403 checks whether the task target information acquired in Step S36A matches the detailed condition input in Step S32A (S37A). When there is a match, this processing ends (Step S3A). When there is no match, the processing advances to Step S38A.

When the processing has advanced to Step S38A, the retrieval process part 403 deletes the execution performance information included in the apparatus ID 461 of the task target information that did not match in Step S37A from the execution performance information acquired in Step S34A (S38A). Thereafter, this processing ends.

This example, which is configured in this manner, also exhibits the same operational advantages as the first example. In addition, in this example, when retrieving a task component, it is possible to specify at least a portion of the configuration of the management-target apparatuses. Therefore, in this example, a more appropriate task component can be selected relatively simply in accordance with the configuration of a management-target apparatus, thereby enhancing usability.

In this example, a case was described in which the software environment (for example, any one of the application, the middleware, or the OS) within which the task component is executed was described as the detailed condition for retrieving a task component. The configuration may be such that it is possible to specify the hardware environment within which the task component is executed either in place of or in addition to the software environment. The hardware environment, for example, may include the type and performance of the microprocessor, the size of the memory, the size of the cache, the internal bus transfer rate, and so forth.

The present invention is not limited to the embodiment described hereinabove. A person with ordinary skill in the art will be able to make various additions and/or changes without departing from the scope of the present invention. For example, the present invention can also be expressed as a method invention as described below.

### “Wording 1.

A method for supporting the creation of an operation task process of a computer system by using a first management computer that comprises:

a microprocessor;

a communication interface part, which is used by the microprocessor, and which is for communicably connecting to a second management computer for managing a computer system that includes at least one or more management-target apparatuses; and

a storage part that is used by the microprocessor,

the method for supporting the creation of an operation task process of a computer system comprising the steps of:

acquiring from the above-mentioned second management computer configuration information related to the configuration of the above-mentioned computer system managed by the above-mentioned second management computer, and an execution result of an operation task process created comprising a plurality of predetermined task components;

storing the configuration information and the above-mentioned execution result of the above-mentioned operation task process acquired by the above-mentioned information acquisition part as the above-mentioned predetermined management information of the above-mentioned storage part;

retrieving from the above-mentioned storage part on the basis of a request from the above-mentioned second management computer a task component candidate that represents a candidate of the plurality of predetermined task components;

presenting the retrieved task component candidate to the above-mentioned second management computer; and

providing to the above-mentioned second management computer a task component selected by the above-mentioned second management computer from among the presented the above-mentioned task component candidates.”

### REFERENCE SIGNS LIST

301 Management server
302 Task execution part
303 Task history preparation part
304 Content acquisition part
305 Configuration information recording part
401 Content management server
402 User information collection part
403 Retrieval process part
404 Content provision part
412 Storage apparatus

1. A support system for creating an operation task process of a computer system comprising:
a first management computer, which is communicably connected to at least one or more second management computers, and which manages information related to an operation task process performed by the second management computer and manages information related to a plurality of task components; and
a second management computer, which manages a computer system that includes at least one or more management-target apparatuses, and which executes an operation task of the computer system in accordance with the operation task process created comprising a plurality of predetermined task components,
wherein the second management computer comprises:
a configuration information management part for managing information related to the configuration of the computer system;
a task component acquisition part for acquiring from the first management computer either all or a portion of the plurality of predetermined task components;
an operation task process execution part for creating the operation task process on the basis of the plurality of predetermined task components acquired by the task component acquisition part, and for executing the operation task of the computer system in accordance with the created the operation task process; and
an execution result management part for managing an execution result of the operation task process by the operation task execution part, and supplying the execution result to the first management computer, and
the first management computer comprises:
an information acquisition part for acquiring, from the second management computer, configuration information related to the configuration of the computer system managed by the configuration information management part and the execution result of the operation task process managed by the execution result management part;
a storage part for storing the configuration information and the execution result of the operation task process acquired by the information acquisition part;
a task component retrieval part for retrieving, on the basis of a request from the task component acquisition part, a task component candidate that represents a candidate of the plurality of predetermined task components, and for presenting the retrieved task component candidate to the task component acquisition part; and
a task component provision part for providing, to the task component acquisition part, a task component selected by the task component acquisition part from among task component candidates.

2. A support system for creating an operation task process of a computer system according to claim 1, wherein the task component retrieval part presents an execution result related to the task component candidate and the task component candidate in an associated manner to the task component acquisition part.

3. A support system for creating an operation task process of a computer system according to claim 2, wherein a predetermined combination of a plurality of task components is included as the task component candidate.

4. A support system for creating an operation task process of a computer system according to claim 3, wherein the information acquisition part stores, in the storage part, respective execution results for the plurality of predetermined task components and an execution result related to the predetermined combination, and
the task component retrieval part is able to present the predetermined combination to the task component acquisition part as the task component candidate.

5. A support system for creating an operation task process of a computer system according to claim 4, wherein the information acquisition part, on the basis of the execution results of the acquired the operation task process, respectively evaluates reliability of the plurality of predetermined task components comprising the operation task process, and reliability of the predetermined combination, and stores the evaluation results in the storage part by associating the plurality of predetermined task components with the predetermined combination, and
the task component retrieval part presents the evaluation result of the task component candidate, the execution result of the task component candidate, and the task component candidate in an associated manner to the task component acquisition part.

6. A support system for creating an operation task process of a computer system according to claim 5, wherein a task start time, a task end time and information related to an error are included in the execution result.

7. A support system for creating an operation task process of a computer system according to claim 6, wherein information related to the existence of a recovery process for coping with the error is additionally included in the execution result.

8. A support system for creating an operation task process of a computer system according to claim 7, wherein the task component acquisition part is configured to specify either all or a portion of the configuration information of the management-target apparatus, which is an execution target of the operation task process, and to acquire, from the first management computer, either all or a portion of the plurality of predetermined task components, and
the task component retrieval part retrieves, from the storage part, the task component candidate that matches the specified configuration information, and presents the retrieved task component candidate to the the task component acquisition part.

9. A support system for creating an operation task process of a computer system according to claim 8, wherein at least either one of information for identifying a software component to run on the management-target apparatus, or information for identifying a hardware component of the management-target apparatus is included in the configuration information.

10. A support system for creating an operation task process of a computer system according to claim 9, wherein the task component retrieval part:
provides, to the task component acquisition part, a condition specification screen for the task component acquisition part to specify a condition for requesting the task component candidate;
retrieves, when the task component acquisition part inputs the condition via the condition specification screen, a task component candidate that represents a candidate of the plurality of predetermined task components, from the storage part on the basis of the input condition; and
presents the task component candidate to the task component acquisition part via a search result screen.

11. A support system for creating an operation task process of a computer system according to claim 10, wherein a plurality of conditions can be specified in the condition specification screen, and
search results of the plurality of conditions are displayed on the single search result screen.

12. A support system for creating an operation task process of a computer system according to claim 11, wherein the task component retrieval part, when the predetermined combination is included in the search results, creates the search result screen by making the display ranking of the predetermined combination higher than another task component candidate.

13. A support system for creating an operation task process of a computer system according to claim 12, wherein there is a plurality of computer systems, and at least one second management computer exists in each of the plurality of computer systems, and
one second management computer of the plurality of second management computers acquires, from the first management computer, either all or a portion of a plurality of predetermined task components on the basis of the execution result of the operation task process in the other second management computer of the plurality of second management computers.

14. A first management computer for supporting the creation of an operation task process of a computer system comprising:
a microprocessor;
a communication interface part, which is used by the microprocessor, and which is for communicably connecting to a second management computer for managing a computer system that includes at least one or more management-target apparatuses; and
a storage part used by the microprocessor,
wherein, by executing a predetermined computer program stored in the storage part, the microprocessor:
acquires, from the second management computer, configuration information related to the configuration of the computer system managed by the second management computer and an execution result of an operation task process created comprising a plurality of predetermined task components;
stores, in the storage part, the configuration information and the execution result of the operation task process acquired by the information acquisition part as the predetermined management information;
retrieves, on the basis of a request from the second management computer, a task component candidate that represents a candidate of the plurality of predetermined task components;
presents the retrieved task component candidate to the second management computer; and
provides, to the second management computer, a task component selected by the second management computer from among presented task component candidates.
